(19) United States
(12) Patent Application Publication
(10) Pub. No.: US 2002/0045154 A1
(43) Pub. Date: Apr. 18, 2002

(54) Method and system for determining personal characteristics of an individaul or group and using same to provide personalized advice or services

(76) Inventors: E. Vincent Wood, San Francisco, CA (US); David Mark Keirsey, Aurora, CO (US); Richard P.N. Milner, San Francisco, CA (US)

Correspondence Address: OPPENHEIMER WOLFF & DONNELLY, P. O. BOX 10356, PALO ALTO, CA, 94303, US

(21) Appl. No.: 09/888,323

(22) Filed: Jun. 22, 2001

Related U.S. Application Data
(60) Provisional application No. 60/213,723, filed on Jun. 22, 2000.

(51) Int. Cl. G09B 3/00; G09B 19/00

(52) U.S. Cl. 434/350; 434/236

(57) ABSTRACT

Method and system for determining personal characteristics of an individual or group and using same to provide personalized advice or services. The system dynamically incorporates several personality dimensions, life style, quality of life, cultural context, demographics, and psychographics, as requested by the test administrator or individual user, and controls and standardizes the testing protocol, and retains test data in such a way that individuals and non-professional users can reliably self administer the tests, save their test results in a system database, and use the results to obtain personality-based advice, content, and people-matching services from a system proprietor.

### FIELD OF THE INVENTION

The present invention relates generally to electronic character analysis systems and methods and more particularly to an improved method and system for determining and classifying individual or group “personality DNA” based upon various personality instruments, behavioral responses, psychographics, demographics, beliefs and preferences as a means to facilitate the delivery of personality based products and services.

### BACKGROUND OF THE INVENTION

Humans have long sought to understand each other's differences in thinking styles. Five centuries before Christ, Hippocrates attempted to improve medical diagnoses by postulating four types of temperaments which he termed: Sanguine, Choleric, Phlegmatic, and Melancholic. Hippocrates ascribed such diversities in the ways people think and behave to varying influences of different bodily fluids. His temperament types, known as the four humors, have been in continual usage until modern science provided better definitions

For thousands of years Native Americans likewise had their “Medicine Wheel” which oriented four perspectives on life to ordinal compass points around a circle. Each of their four styles were symbolized by animals as follows: the Buffalo (north) represented cool wisdom, the Mouse (south) portrayed innocent trust, the Bear (west) characterized staying in place, and the Eagle (east) illustrated illumination and vision beyond.

With the advent of modern science and medical surgery, research has increasingly traced the causes of people's differences to varying operations in the brain. The work of noted Swiss psychologist Carl Jung in the 1920's and '30s led him to gather that there were four functions of the mind, two pairs opposing each other, which he labeled “Thinking” versus “Feeling” and “Sensation” versus “Intuition.” He believed that although all people possess these abilities, one of the four functions dominates a person's personality. Based on the mental functions and attitudes that Jung described, in the 1950's psychologists Isabel Myers and Katherine Briggs developed a personality test, the now widely used Myers-Briggs Type Indicator (MBTI). The MBTI rates people's written responses to questions to measure four sets of opposing characteristics. Each set is a continuum with opposite ends designated by letters which denote the pair's behavioral extremes:

Extroversion E . . . I Introversion

Sensation S . . . N INtuition

Thinking T . . . F Feeling

Judging J . . . P Perceiving

Testing identifies a person's gravitation toward one end or the other of each set of characteristics, and by the combination of which sixteen types of personalities that are possible (for example, ESTJ, ISTJ, etc.).

In the 1970's and '80s, Ned Herrmann conceived of different modes of thought occurring in various regions of the brain, in the higher level cortex and lower level limbic system. His Whole Brain Model comprised four quadrants of thinking styles linked to particular regions of the brain, with processes occurring on the left or right.

A-quadrant

Analytical, quantitative logical, fact-based

D-quadrant

Intuitive, holistic, integrating, synthesizing

B-quadrant

Organized, sequential planned, detailed kinesthetic

C-quadrant

Interpersonal, felling-based emotional

In Herrmann's model, the four clusters of processing are typically available in each person, but one or more of the clusters is naturally dominant in a person's temperament, similar to Jung's theory. Through two decades of testing and applying his model to organizations, Herrmann amassed findings which indicate that the population is evenly distributed among these four types of thinking specialties. That is, 25% of the people show dominance in A-type analytical thinking, another 25% show dominance in B-type organized thinking, and so on around all four quadrants. This data suggests that groups and societies operate in such a way that each person's specialties of thought are balanced among the group as a whole. Although people are not all created equal, different styles of thinking appear to serve equally weighed roles in balancing each other to optimally achieve the group's common purposes. This generally fits with data in the 1970's by psychologists David Keirsey and Marilyn Bates. Their studies of married couples with Myers-Briggs testing showed an equal distribution among particular personality types: 25% were TJ's (favoring Thinking with Judging), 25% were FJ's (Feeling with Judging), 25% FP's (Feeling with Perceiving), and 25% TP's (Thinking with Perceiving). These Myers-Briggs types roughly equate to sides of the square Herrmann model (Herrman's AB side being TJ's, BC side FJ's, and so on). This data corroborates the understanding of thinking styles as a system in which each combination of thinking processes is offset and balanced by its corresponding opposite among the population as a whole.

In the 1980's Katherine Benziger modified Herrmann's model with new theories by neurosurgeon Karl Pribram. Pribram suspected that the four different modes of thought were all processed in the uppermost cerebral cortex of the brain, but in its different quadrants of the left and right hemispheres' frontal and basal lobes. Although the locations of the processing were different from Herrmann's, her four-way model of modes of thought was similar:

Front Left quadrant

Analyzing, evaluating. Making goals and decisions

Front Right quadrant

Imagining conceptualizing, generating holistic images

Basal Left quadrant

Sequencing, planning Details, carrying out orderly routines

Basal Right quadrant Harmonizing, synthesizing, associating expression and meaning

Before returning to the development of the present invention, it is noted that in addition to those models already mentioned, there are now many other four-way models of temperament and personality in common use by psychologists and human development specialists.

There are other such systems which categorize temperament, personality, or behavior into four categories that are identified by letters, words, and/or animal icons. Virtually all of these systems use individual written testing and scoring to determine one's personal style.

Other related methods and devices for typing personalities exist, yet none possess the unique characteristics of the present invention.

Virtual (Psychological) Modeling

Temperament is a predisposition to act via certain predictable behavior patterns. Personality temperament has been extensively studied and certain temperaments shown to be identifiable for a several thousand years. By asking a set of questions, a temperament can be assessed. The Keirsey Temperament Sorter is an example of a set of questions that when aggregated into a “temperament” can help predict an individual's behavior patterns [Please Understand Me II, by David Keirsey] The Keirsey Temperament Sorter asks 70 questions and aggregates the responses into four basic temperaments, each with four variants, to create 16 temperament variants. When a person answers these 70 questions, a great deal of the behavior patterns of the individual can be inferred from the assessed temperament

Temperament as a Financial Indicator

The notion of temperament regarding an individual's financial behavior (specific attitudes regarding planning, saving and investing, wealth and family protection, as well as making financial decisions under conditions of risk and uncertainty) has been studied and clear patterns of a set of temperament profiles have been devised. However, financial behavior for each individual is complex and depends, not only on temperament, but also on a host of other factors such as life style, cultural context, and financial knowledge and experience in investing. Models of personality, financial temperament and human behavior can improve the client's satisfaction by considering the appropriate influence points of the client and the selection of appropriate financial content, services, products and advice, which will be delivered, primarily on the Internet to end users or as a tool used by financial professionals and their organizations to enable them to better “know” and to better service their customers.

To better help the individual in a financial process, such as investing, a thorough knowledge of the individual's psychological profile, financial situation, and experience is crucial. In the past, this has been the role of a human financial advisor (“Advisor/broker”). Soliciting information about individuals in an incremental way on the web, constant analysis of financial behavior, and adjusting of psychological models, will further improve the prediction of behavior and ultimately help the individual learn quicker and make better financial decisions, customized to his style and circumstance.

It is believed that when studying human behavior or measuring people's reactions to situations, we find patterns that allow us to group people by their similarities. The method for doing this has traditionally been personality testing, and many theories and instruments have been developed over the years to help explain the similarities and differences in people. One such test is the Keirsey Temperament Sorter. Developed in 1978 by David West Keirsey, the sorter categorizes people into 4 main Temperaments each with 4 variants for a total of 16 personality types. Dr. Keirsey's work is based upon the works of Carl Jung, who wrote about 8 main personality types. It is also based on the work of Isabel Myers, who developed the Myers Briggs Type Indicator (MBTI), a similar instrument that categorizes people into essentially the same 16 personality types.

The primary uses of the 16-type model have been in the corporate setting, individual career counseling, and psychotherapy. Many companies try to improve communication between employees and offer workshops and seminars to foster better understanding and communication among employees. If each employee can understand the values and motivations behind his/her own personality type and then understand those of the other types, then personality-based conflicts can be recognized, understood, and better managed. This leads to a healthier work environment and higher productivity. Traditionally, personality testing requires the oversight and interpretation of a trained psychologist. This training or certification is done to ensure quality control and standardization in the interpretation of results and management of emerging psychological and ethical issues.

Summary of the Invention

A primary objective of the present invention is to provide a means by which uniquely customized products and services can be offered based upon the personality of the customer.

Another objective of the present invention is to provide a method and system for determining and classifying an individual's “Personality DNA” based upon various personality instruments, behavior, psychographics, demographics, beliefs and preferences as an integral part of the delivery of personality based products and services.

Still another object of the present invention is to provide an Internet based personality assessment system that can be used as an adjunct to the determination and delivery of individually tailored goods and services.

Briefly, the present invention provides a test administration process and system that goes beyond most personality tests used to assist professionals in diagnosing 1 of 16 personality types. The system of the present invention dynamically incorporates several personality dimensions, life style, quality of life, cultural context, demographics, and psychographics, as requested by the test administrator or individual user, and controls and standardizes the testing protocol, and retains test data in such a way that individuals and non-professional users can reliably self administer the tests, save their test results in a system database, and use the results to obtain personality-based advice, content, and people-matching services from a system proprietor.

Although certain psychographic profiling applications currently exist on the Internet, such methods are generally based on the user's online behavior as measured by their click history and their purchase history. The approach of the present invention is unique in that it is based in large part on the user's measured personality type. And although other matching services exist, almost all of them rely exclusively on demographic data as the basis for their Content and People Matching algorithms. The present system uses demographic data, but more importantly, uses personality, psychographic, cultural context, quality of life, and life style characteristics in order to more accurately match users with content, advice, and other people.

The present invention recognizes that every person (user) is different from other users, and the way in which those differences are measured and identified allows one to articulate distinctions between the present invention and the prior systems. People are different because they possess different traits and preferences, because they behave differently, i.e., they react to situations differently, and because they possess different attitudes and beliefs. These traits will generally be referred to herein as “characteristics.”

In accordance with the present invention, a personality is defined depending on which groupings of characteristics are chosen. The system allows for selection of a large number of combinations of characteristics, and therefore allows for many different personality definitions and measuring schemes. Since a user's personality is made up of a number of characteristics, the present invention identifies and measures the characteristics of the user to classify the user into a selected personality scheme, and matches advice, content, and other people with the user based upon the results of selected tests.

A single characteristic is defined and identified by a pattern of answers to particular sets of questions and/or patterns of behavior and/or actions. It may also be defined and identified by a single answer and or behavior/action. The system and method of the present invention compares the user's characteristics to stored predetermined answer patterns as indicators of characteristics, but is also self-modifying to improve accuracy.

Measuring a user's characteristics can be accomplished in one visit with the system, but is more likely to occur over multiple visits.

An important advantage of the present invention is that it allows a user to perform an online self evaluation of his personality traits and characteristics and then obtain specialized goods and services tailored to meet his particular needs.

Another advantage of the present invention is that it provides a method and system that can be used and even modified by the user to perform specialized personality self-analyses designed to accurately relate him to his associations, product needs, environmental needs and service requirements.

Still another advantage of the present invention is that it makes possible the creation and delivery of content, advice, and people profiles determined from a user's responses to a series of personality tests, demographics questions, both on-line and off-line behavior, psychographic testing, life style and quality of life questions.

These and other objects and advantages of the present invention will no doubt become apparent to those skilled in the art after having read the following detailed description of the preferred embodiments which are described in the following specification and illustrated in the several figures of the drawing.

### IN THE DRAWING

FIG. 1 of the drawing is a block diagram generally illustrating one example of a computer network environment in which the method and system of the present invention may be used;

FIG. 2 is a block diagram generally illustrating a personality based personalization system in accordance with the present invention;

FIG. 3 is a diagram generally illustrating a data collection process in accordance with the present invention;

FIG. 4 is a diagram generally illustrating the question and/or test element selection process in accordance with the present invention;

FIG. 5 is a diagram generally illustrating the multimedia presentation selection method of the present invention;

FIG. 6 is a diagram illustrating dynamic question and answer presentation in accordance with the present invention;

FIG. 7 is a diagram schematically illustrating user classification in accordance with the present invention;

FIG. 8 is a diagram generally illustrating scoring alternatives in accordance with the present invention;

FIG. 9 is a block diagram generally illustrating content matching in accordance with the present invention;

FIG. 10 is a diagram generally illustrating a content matching algorithm in accordance with the diagram of FIG. 9;

FIG. 11 is a block diagram generally illustrating an advice matching algorithm in accordance with the diagram of FIG. 9;

FIG. 12 is a block diagram generally illustrating a people matching algorithm in accordance with the diagram of FIG. 9;

FIG. 13 is a block diagram generally illustrating an automated updating algorithms in accordance with the present invention;

FIG. 14 is a diagram schematically illustrating an alternative embodiment of the present invention used to perform group testing; and

FIG. 15 is a simplified flow diagram illustrating the basic process steps implemented by a presently preferred embodiment of the present invention.

### DETAILED DESCRIPTION OF PREFERRED EMBODIMENTS

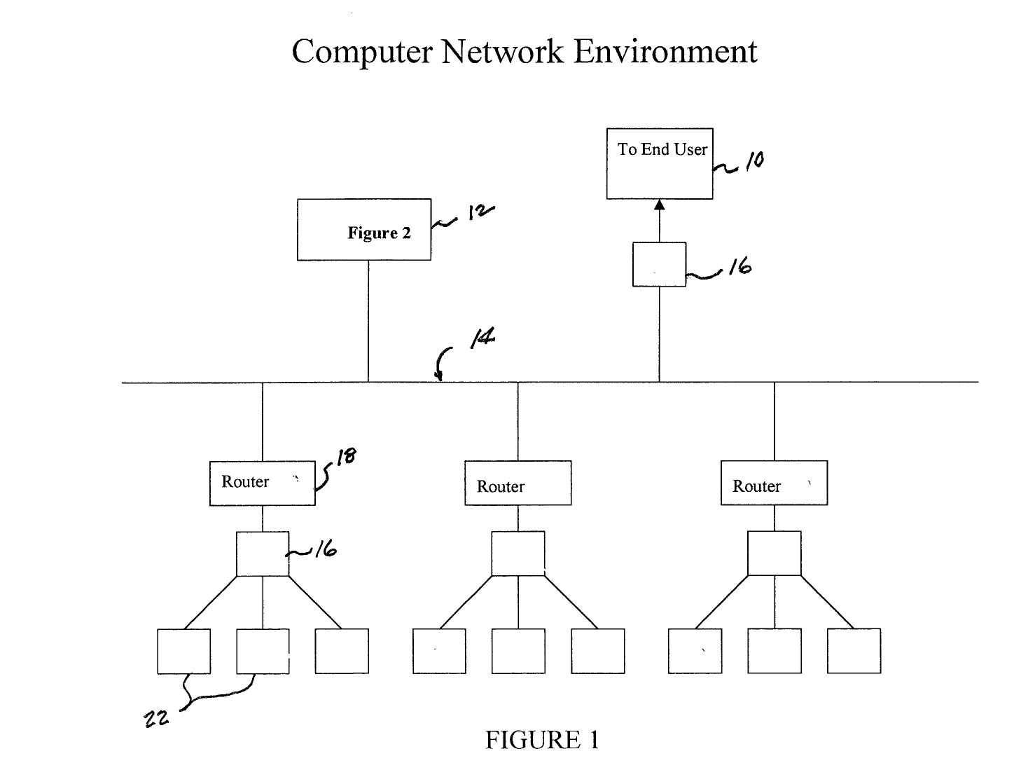

Referring now to FIG. 1 of the drawings, a simplified diagram is presented illustrating a computer network environment in which the present invention may be practiced. According to this illustration, a user 10 may use his computer to visit a system proprietor's website running on the Internet, an Intranet, an Extranet, or any other electronic media platform 14. The top half of FIG. 1 illustrates one user accessing the system from a single computer terminal 10 via an internet connection which may include a server 16. The lower half of FIG. 1 illustrates multiple users within one or more extranet or intranet networks which may include routers 18, servers 20, and a plurality of end user terminal 22.

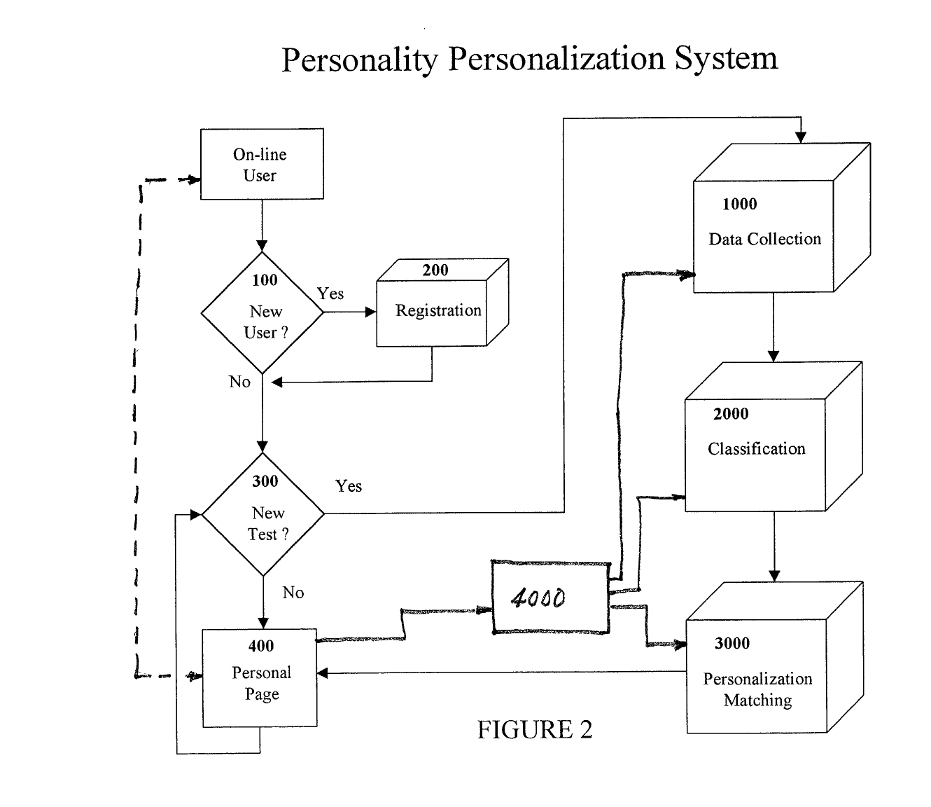

In FIG. 2, a block diagram is presented showing, in general terms, the registration, testing, data collection, classification and personalization matching processes of an embodiment of the present invention. As a user logs on to the system, a determination is made at 100 as to whether he is a new user or a returning user. If he is a new user, he will need to go through a registration process (200). The registration process asks the user to provide a login Id and password. If the user is new, the system will generate a unique Id for assignment to the him. After the registration and/or logon process is completed, the user may proceed at 300 to take the Keirsey Temperament Sorter test or any of the other personality tests available, or may choose to proceed to take a new test, or simply visit his/her personal page (400) to view prior test results.

The data collection “module” or sub-process represented by block 1000 begins at the registration process wherein certain basic information is acquired. This data may also be used by the system to initially classify a user.

As suggested above, the foundation of the present invention lies in the creation and delivery of content, advice, and people profiles determined from a user's responses to a series of personality tests, demographics questions, both on-line and off-line behavior, psycho graphic testing, life style and quality of life questions. As the user submits information, the resulting data created is stored under the user's unique Id, allowing the user to retrieve his/her results in the future.

The method and system of the present invention subsequently uses, in the “module” or sub-process represented by block 2000, the data collected in the sub-process of block 1000 to categorize or classify the user according to a classification scheme. The user may also be classified using one or many categorizations, schemes or scoring methodologies. The present invention accommodates any personality sorting method as well as any test scoring method. However, notwithstanding the fact that the user may be classified using a predetermined personality sorting scheme and scoring methodology, he/she will also have the ability to alter the scoring and sorting process to meet his or her testing needs. At the end of this sub-process, the user will have a least one classification result obtained from one sorting scheme.

After categorization, the sub-system of Module 3000 of the system of the present invention will analyze all available content and will determine the most relevant content to be presented to the user. The system may also deliver advice and person-matching services using the data collected during the sub-process of block 1000 and the user classification data as determined from the sub-process of block 2000. The user will be able to re-enter the system at a later date, provide and save new information, access old information, and use old and new information to sign up or purchase products and services that utilize personality information. Upon completion of this process, the user will be able to return to his/her personal page 400.

The sub-system of a module represented by a block 4000 of the system allows for user feedback to improve the accuracy of the matching of content to the user. Whereas the classifications are determined based upon a set of scoring and sorting rules, and whereas the matching of elements is based upon individual preferences and on classification preferences, the system allows for internal feedback to improve classification accuracy and to improve the accuracy of matching users with elements. The feedback is used to alter the scoring rules in Module 2000 and the relevance strength values used in Module 3000.

Module 1000 DATA COLLECTION

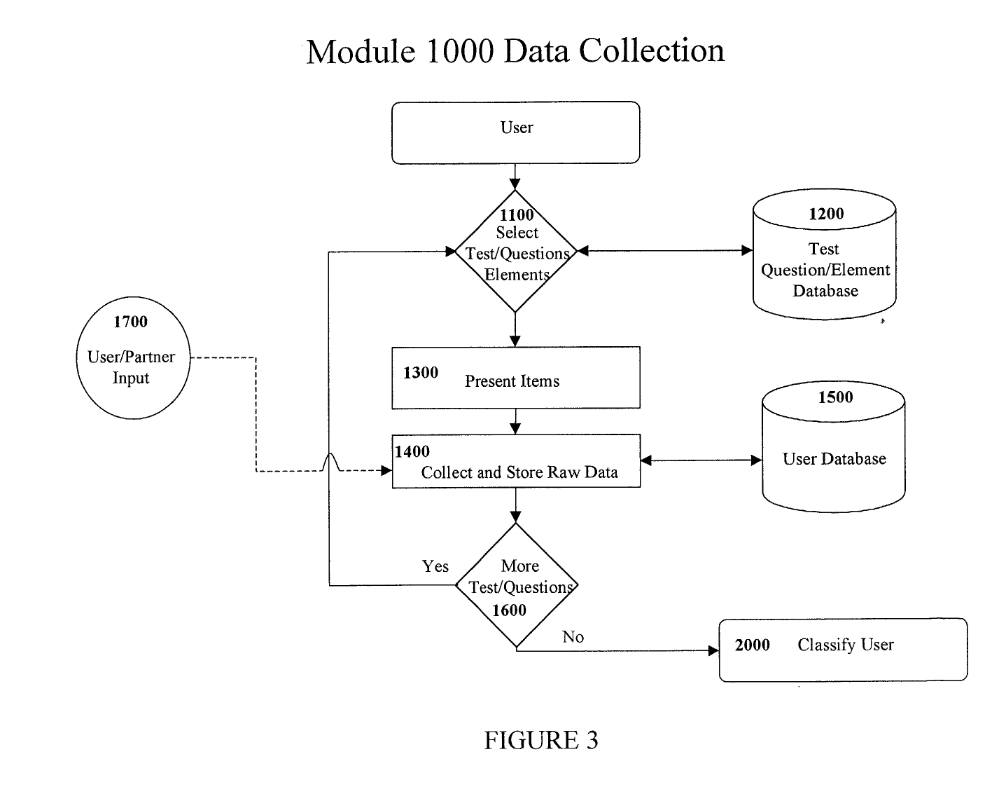

Referring now to FIG. 3, the sub-process of Module 1000 is illustrated. In this process the user will provides information that the system to subsequently categorize the users characteristics. In this module, the sub-system determines which test questions to ask the user, the order in which the questions are to be presented, the media type of the questioning, and the storing of all obtained data to a user database.

After logging onto the system as described above, the user is asked at 1100, to select one of many test(s), quiz(zes), or sorter(s), and retrieves a set of questions from the test question database 1200. The purpose of the test at 1100 is to determine which questions and/or which testing elements and testing format will be presented to the user in block 1300. Because the user may already have provided certain information during a previous visit, and the test question and testing element database can contain thousands of possible questions, the system must decide (in 1100) which questions are not needed and which ones are needed. The test at 1100 will also determine how the questions or testing elements will be presented to the user. This may be in the form of questions or may be observations from situational analyses.

The list of question types that the system may choose to present to the user include but are not limited to the following:

Demographic Data

Demographic data is generally factual in nature and provides the system with important information that is used to identify the user. Demographic data may be used when simply processing a purchase order, or may be used to tailor advice and content to an individual. The following provides a list of the type of data that might be gathered.

a. Age

b. Address

c. Phone number

d. Marital Status

e. Gender

f. Education

g. Language

h. Country

i. Race

j. Religious Affiliation

k. Political Affiliation

l. Income

m. Career/Job

n. Industry

o. Family Information

p. Personal Experiences

q. Personal History

Psychographic Data

This type of data is much more personal and subjective in nature. The system uses the user's beliefs, attitudes and motivators to provide more robust matching of content to the user. This type of data may also have significant impact on ultimately matching content to users. The following is a non-exhaustive list of the types of psychographic data used by the system.

i. Values and Value Statements

ii. Cultural Values

iii. Sub-cultural Values

iv. Socioeconomic Status

v. Religious Beliefs

vi. Political Beliefs

vii. Attitudes

viii. Habits

ix. Intrinsic Motivators

Personality Data

This data generally includes any data that measures personality, intelligence, cognitive skills, competencies, and creativity. Just as demographic data and psychographic data is used in accordance with the present invention, personality data is used to add additional information in order to make the system more personalized. The following is a non-exhaustive list of personality data used.

x. Any Personality Test Quiz or Sorter

xi. Personality Test based on Carl Jung's work

xii. Personality Test that uses 16 personality type categories

xiii. Myers Briggs Type Indicator

xiv. Keirsey Temperament Sorter

xv. Enneagram

xvi. Rorschach

xvii. Competency Based

xviii. Skills and Interest Inventories

xix. Learning Style Based

xx. IQ Tests

xxi. Intelligence Tests

xxii. Cognitive Tests

xxiii. Creativity Tests

xxiv. Emotional Intelligence

xxv. Social Intelligence

Life Style and Quality of Life Data

This type of data could be viewed as demographic data but with a qualitative nature. This type of data includes particular life style preferences and the level of happiness/displeasure associated with a particular aspect of a user's life.

1. renter or homeowner

2. driver or non-driver

3. health status—excellent, good, fair, poor

4. alcohol consumption per month

5. cigarette consumption per month

6. primary source of news/information—television, radio, internet,

7. magazines, books

8. hours worked per week

9. stress level—on a scale of 1 to 5

10. physical health

11. psychological health

12. social relationships

13. environment

Application Specific Data

What distinguishes these questions from the others is that these questions measure personality dimensions that are not measured by the other tests. For example, what traits one values most in other people. Or what key aspects of a job are necessary to make one happy, etc. Knowing these additional dimensions of the user allows the system to provide customized content by application.

The user or system decides if additional questions are to be presented. This decision is based upon a selected application-specific product or service to be used by the user. The user may be asked questions about finances, career, human relationships, education or business.

Behavior Data (Provided)

There are two types of behavior data that are collected and used by the system; “provided” and “observed”. The first, “provided”, consists of observations of behavior input by the user or by a third party service provider. This information may include previous actions taken by the user, and represents behavior and actions that may have occurred on another system or as part of the user personal history. This information is gathered through the system website and from user behavior information or inputs from third parties.

For example, a stockbroker using the system may wish to add stock-trading history into the data collected on his/her client or a retail business may wish to enter the offline purchase history of the user. Behavioral information gathered may also include, but is not limited to, online purchase history, online investment history, registration history, etc. In both of these examples, the system will store the information as part of the user's profile in database 1500.

Behavioral Data (Observed)

The second type of behavioral data is “observed”. This type of behavioral data also includes observation of a user's actions on the system website; such as for example, the recording of each mouse click and the corresponding cursor position to effectively record the user's motions/movements during a session. Information gathered may also include a session identifier, information regarding specific actions taken, ads that the user clicks on, articles the user reads, the referring link, the orientation of the items, and other user activity. This step also records the user's viewing history as indicated by the screen views displayed to the user during a session. Specifically, a user's viewing history consists of the pages, ads and articles viewed, the time the items were viewed, and the identification of the screen views. Observed behavior also includes the user's purchase history.

Declared Preferences

Understanding declared preferences provides additional information that is used to determine which content, advice, and people matching criteria the system should deliver to the user. Therefore, the system gathers information about specific preferences for categories of interest to the user. In the preferred embodiment, the various categories of interest will be listed and the user will rank the listed items based on the level of interest which he/she has.

For example, the user may be asked for favorite sports, and then be presented with a list that would include, Football, Basketball, Tennis, Auto Racing, etc. With each of these categories, the user is asked which teams and players he/she likes. The user may also proceed down a list of hobbies, interests and product information.

Declared preferences may also be gathered for application-specific purposes. For example, in a financial application, a day trader may prefer a particular layout and content specific to trading in the market, while a fearful investor may wish to see less trading and more secure long-term investment related content.

A user wishing to receive career advice may be asked to provide job attribute preferences (i.e. Working outside, attention to detail, working on teams). A user wishing to receive relationship advice may be asked to provide preference information for behavior in their partner. The purpose of declaring preferences is to provide the system with greater accuracy and relevance for providing advice.

Declared preferences may also include colors, shapes, content layout, etc. For example certain users may prefer a different orientation, color scheme, screen quadrant/location or the like, indicated with respect to the category of information. This information could be used to alter the web layout in real time given the users personality type. The following is a non-exhaustive list of preferences that are used in accordance with the invention to better match content and provide advice.

a. Travel Preferences

b. Movie Preferences

c. Entertainment Preferences

d. Advertisements Preferences

e. Food Preferences

f. Book Preferences

g. Brand Preferences

h. Colors Preferences

i. Products Preferences

Scenario Based Testing and Elements

Actions measured also include scenario-based testing that attempts to measure behavior given a particular situation. Scenario Testing is based upon what one sees and hears in a situation where the user is not directly involved in the scenario. For example, the user is presented with video content of a situation, and is then required to respond in some manner. The user may watch a video of a character and then be asked whether he/she identifies with the behavior of this character. The user may also be asked to rank or score the behavior so that the system can categorize it into one or more separate personality types. The user may input data using mouse, touch screen, keyboard, and voice. A specific example may include a user being tested for how he/she reacts in a situation where a burglar has entered their home and pulls out a gun. The user will be asked what he/she would do next, and be asked to pick one of the options: (1) negotiate (2) run or (3) shoot. How the user responds is stored in the database and used in conjunction with the other raw data collected. The answers are also stored into the user's profile.

Roll Play Based Testing and Elements

Actions can also be measured using roll play wherein the individual is directly involved in the testing, giving it a greater sense of realism. The system records data in two ways. The first is data from behavior observed offline during role-play then input into the system. The second way is to measure the data directly by observing the user in role-play online. For example, the user controls a character and interacts with others online. Actions and behavior are observed by the system and used to determine a classification.

As will be further explained below, once the test questions/elements are selected at 1100 from data base 1200, they are presented to the user at 1300, and the response is collected and stored in the data base 1500. If more testing is required, as determined at 1600, then the system reverts back to block 1100 and the above process is repeated, perhaps with new direction. During the testing process, and as suggested by block 1700, it may be desirable to include additional user information or third party information into the raw data collected at 1400 and stored in data base 1500. But once the testing and data gathering is complete,the system process proceeds to the classification phase at 2000.

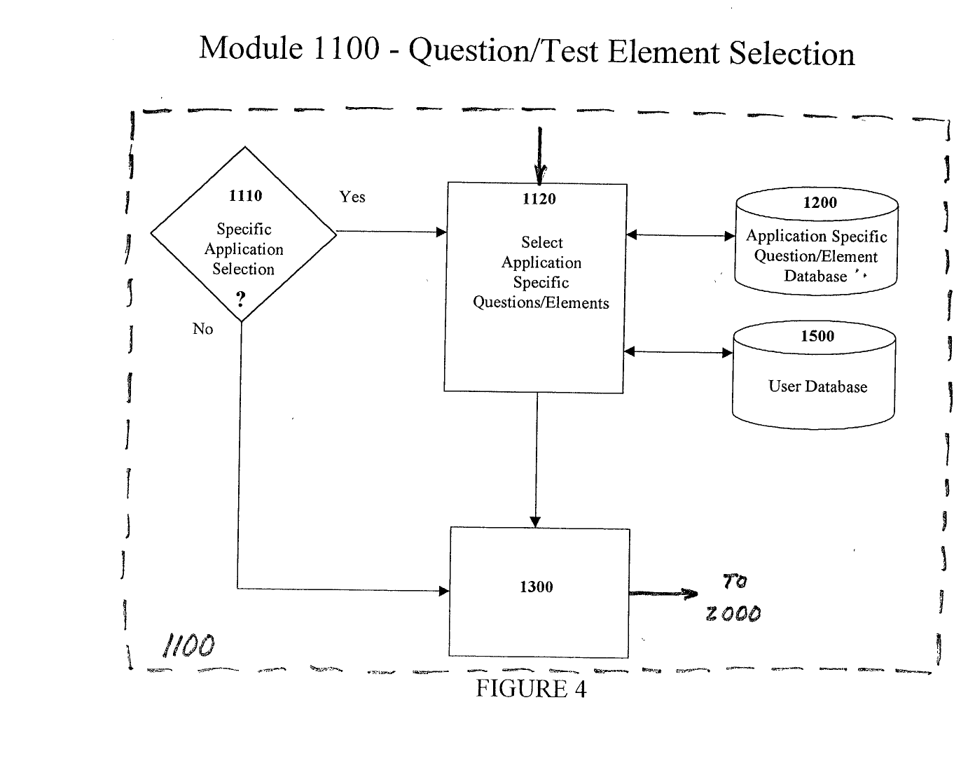

But before proceeding to the classification process, the reader should turn to FIG. 4 wherein additional details of the selection module 1100 (FIG. 3) are illustrated. As indicated at 1120, the system determines which test questions and test elements to present to the user by first determining at 1110 the application for the questioning. This information is provided to the system just after log-on when the user selects a specific test, or requests a particular product or service. Based upon data that may already exist for a particular user in object 1500, and the particular application selected, application-specific questions/elements are selected at 1120 and accessed in database 1200 and retrieved therefrom. If the user requests a specific personality test for example, then the system will select a predetermined set of questions for that test. If the user requests a specific service, several tests and/or application-specific questions will be selected. The selection at 1120 will also determine whether or not behavioral and role-play testing elements are to be used. With the selected questions and elements, the user then proceeds to module 1300 to determine how the testing will be presented, i.e., will it be via a multimedia presentation or a question and answer presentation.

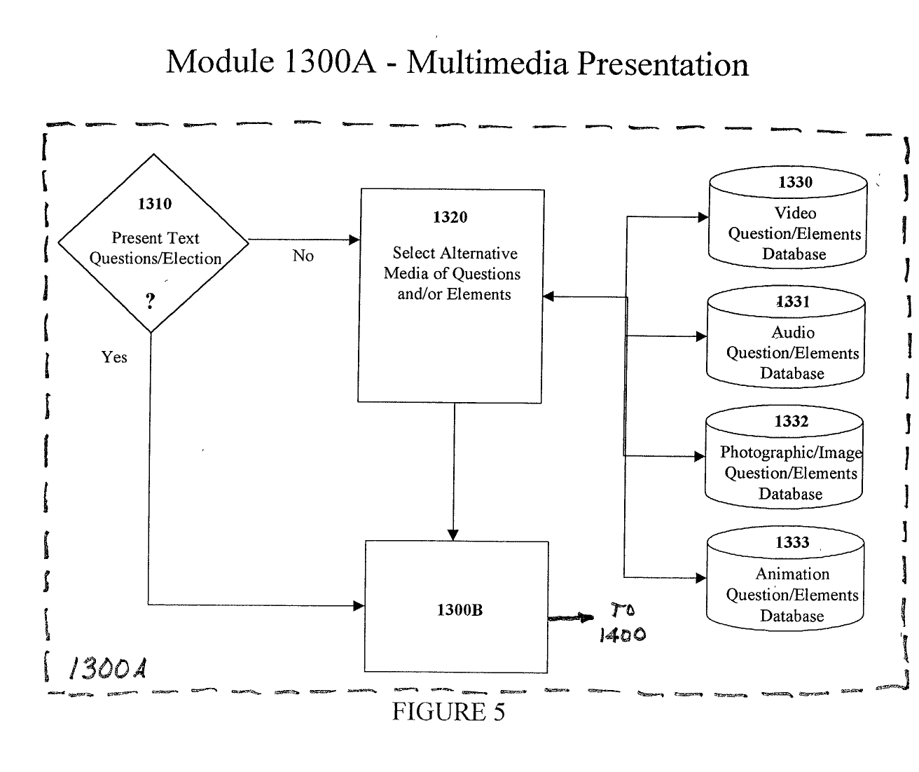

If the testing is conducted by use of a multimedia presentation, the process may include the functions illustrated in FIG. 5. As suggested by the labels on data bases 1330-1333, every test question or series of questions can be presented in a number of different media. Specifically, each could be posed as text, audio, video, animation, photographic, image, color, or shape. For example, the question, “Are you an extroverted person?” could be asked simply as text, or it could presented as a pre-recorded voice and played to the user. Furthermore, the system could play a video of a person asking the question, or even provide a scenario where the user is observing some extroverted behavior and then asked to determine if he/she ever exhibits that type of behavior, or if he/she identifies with the person exhibiting the behavior.

The system starts at 1310 to determine whether or not text questions will be asked or another format will be used. If text is not used, then the system proceeds to select at 1320 the format that will be used to present the questions. This decision is based upon the type of application, the connection speed of the user, and the availability of alternative media formats. Database 1330 contains the video content for all testing. Entire personality tests can be done using an actor simply stating the question to the user. Database 1331 contains the audio-only elements for test questioning. A personality test could be stated verbally to the user or the system could use sounds as part of a test. Database 1332 provides photographic images and drawings. A question could involve the interpretation of a photograph or a drawing. And Database 1333 stores the animation test questioning elements. This could be in the form of still cartoons, or animated motion. Once the question media formats have been selected, the process proceeds to 1300B wherein determination is made as to how the selected questions/test elements are to be presented.

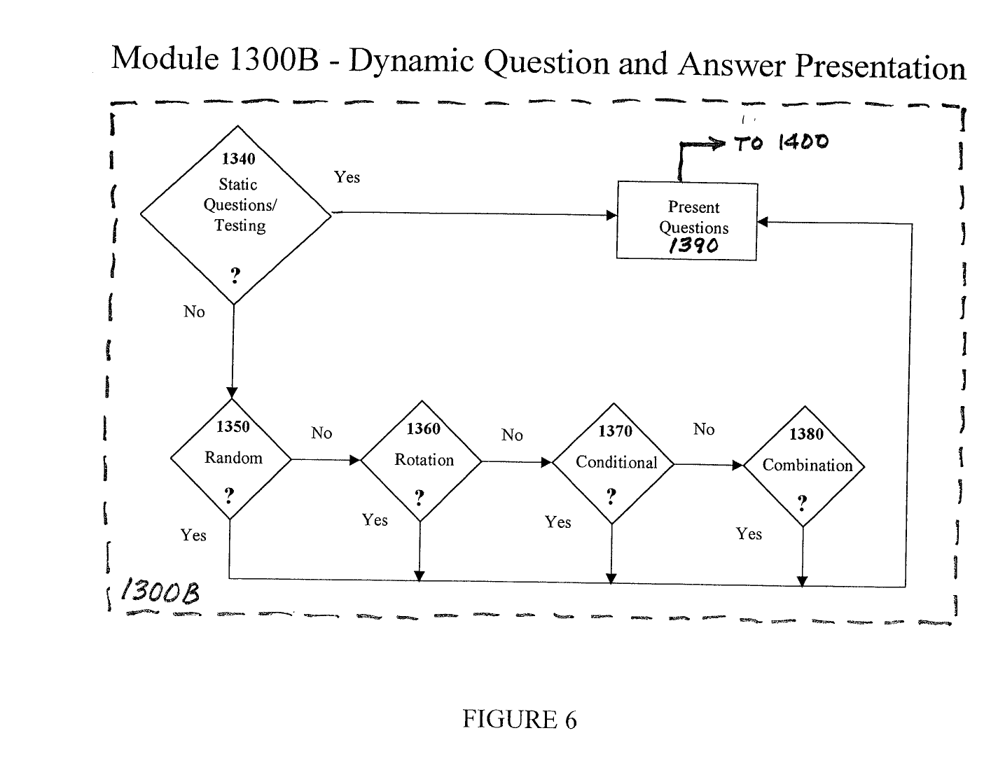

The presentation selection process is shown in the diagram of FIG. 6. Text based questions may be presented the same way each time, or the order of the questions and answers may be randomized. Typically, the questions, or series of questions, forming a personality test will be asked in the same order each time to different users. However, the invention can also provide for a variety of presentation methods. As indicated at 1340, the system determines whether the question order will be variable or remain the same (“static”). If static, then the system will present a predetermined number of testing questions to the user in the predetermined order. If not static, then the system proceeds to 1350 where a determination is made as to whether the order of the questions and answers is to be randomized. If no randomization occurs, then the system will proceed to determine at 1360 whether or not to rotate questions in or out so that two users may see different test questions for the same test. This test also determines how many questions are to be used. If the system decides that no rotational changes are to take place, it proceeds to determine at 1370 whether or not the system has chosen conditional testing. If so, then a question or a section of questions may be determined by how the subject has answered previous questions. In other words, the questioning becomes deterministic. Finally, if conditional is not chosen, then the system proceeds to 1380 to determine if there is to be a combination of the randomization, rotation, and conditional procedures. At this point the questioning process is defined and presented to the system user for response.

As indicated above in FIG. 3, the user's responses are then collected as raw data at 1400 and stored in user database 1500 under the unique id created for that user. Each of the object types listed above with respect to module1300 will have different methods for capturing the data, ranging from mouse clicks, keyboard entry, touch screen, etc. The system will update and create histories for each user in database 1500. The collection and data delivery is tailored to each question and test type. For the text-based questions, an HTML format is used to deliver information to the database. As briefly alluded to above, the data collection at 1400 also permits the incorporation of outside inputs 1700 with responses from 1300.

All information gathered in Modules 1000, 2000, and 3000 that relate to a unique user is stored in the User Database 1500. The system also collects general information about the user's computer as well as information on each computer session undertaken.

When returning to the site, the user can access database 1500, or the data can be used by the system to deliver future services by the system proprietor or his designees. Database 1500 contains all of the data that relates to the user. It includes the raw data collected in in response to the presentation at 1300; information created in Module 2000, and related information for the matching products and services (Block 3000).

Upon completion of a particular test, the user may be also presented with additional questions or additional tests. If so, the system repeats the preceding steps as illustrated in FIG. 3. If not, then the process proceeds to Module 2000. For example, the user may wish to purchase a service that requires completing more than one test (e.g. a personality test, a psychographics questionnaire, and a role playing test.) The tests could be combined into a single series of questions or may be asked separately at different times.

As mentioned above, the system allows the user, other users or a third party service provider to enter information into the system. This information may include any information that has been gathered from the user. For example, a headhunter may input certain information that he has gathered about a user into the system that may be relevant when delivering a service oriented for jobs and careers. This information may include the user's resumes, salary requirements, interviews, job history, and feedback from others or even personality data. As another example, the user may also enter a job listing and post job requirements including the skills, competencies, personality traits etc. of the ideal user. This information would e used to find the ideal job applicant based upon user data records in database object 1500.

The third party can either enter the information using an HTML interface with the system, or by directly merging data into the program. Information may be in the form of responses to questions answered on an outside platform, or may be the answers and results that have been calculated on an outside platform. The system then creates a new account and saves the information for new users, or simply stores the information for returning visitors. The system again stores all the information in the user database 1500.

The preferred embodiment uses PDA devices where test questions that are contained and answered on the PDA are either scored on the PDA and input into the invention for the matching of content or the scoring and matching occur within the system after the answers are input into the system. The user uploads his or her information via step 1700 and proceeds to 1400. In this example, steps 1100 through 1300 occur on the PDA and not on the system. The user's information is stored in database Object 1500. The process then continues with block 2000. The user may on subsequent visits use the invention just as if he/she had conducted steps 1100-1300 on the system. The user in this example may also continue to block 2000. The PDA may use a wireless connection to connect directly with the system or connect via a terminal interface that is connected directly to the system.

Module 2000 CLASSIFICATION

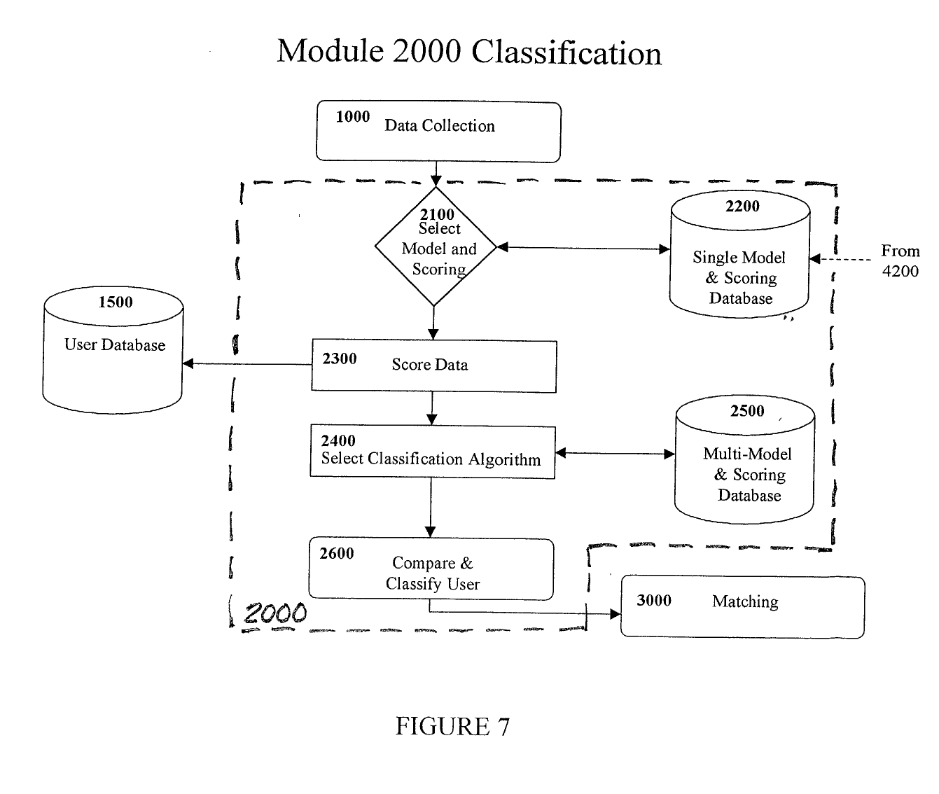

Referring now to FIG. 7, a simplified diagram of Module 2000 is presented. In accordance with the present invention, raw data provided by each user via their answers and behaviors and collected in Module 1000 are scored and compiled by algorithms and standardized into alphanumeric representations in Module 2000. This sub-process standardizes the data so that the user's profile can be compared to personality models and to the profiles of others.

Generally stated, the classification model and its corresponding scoring methodology to be applied to the data collected from block 1000 are selected at 2100. In accordance with the present invention, a model is defined as a sorting roadmap where each possible result or “node” is a clustering of many personality traits. Nodes can be very narrowly focused to screen for just one characteristic, or they can be broadly defined combinations of characteristics. Nodes also measure the degree to which a personality dimension exists. Each dimension adjusts on a scale (i.e., 1-10) to measure the degree to which a user possesses such dimension. For example, if 5 personality dimensions are used to define a node, the node may be defined as follows:

Dimension One=2

Dimension Two=5

Dimension Three=10

Dimension Four=1

Dimension Five=8

The above combination of such dimensions constitute a node and indicate a personality type. Nodes are also defined as weighted averages of dimensions and user traits. Each personality methodology or scheme contains several nodes to represent the personality dichotomy.

The selection of a scoring methodology or personality scheme is determined either by the system or by the user. One or more models may be selected depending on the application of interest to the user.

Once the selection of a personality classification model and a corresponding scoring algorithms/methodology occurs, the data collected from Module 1000, is scored at 2300.

The selected personality model(s), and scores received, and the data collected from Module 1000 are then used at 2400 to select the type of classification algorithm to be used in categorizing users. In cases where a single personality model is selected, the classification of the user is the same as the result received from block 2300. However if multiple models are used, step 2400 will further categorize the user by selecting a model to incorporate many personality, psychographic, demographic, and behavioral models. The system is able to recognize certain question and test combinations and then access the database 2500 to retrieve the selected classification scheme.

Once the classification algorithm has been chosen, the system compares at 2600 the user's scores and results from step 2300 and step 2400 against the classification scheme(s) chosen from database 2500. The system then determines the closest match and presents the classification to Module 3000.

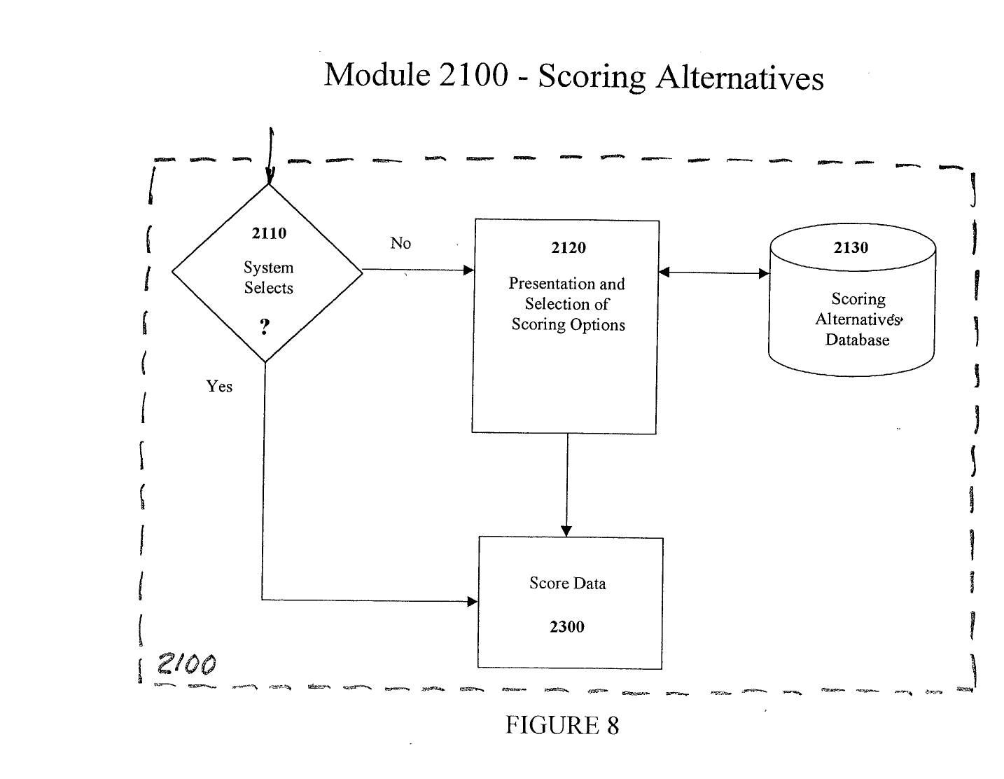

Referring now to FIG. 8, the model and scoring process at 2100 is further illustrated. The system has two primary ways to determine how the data provided from Module 1000 is to be scored. The first is to have the system determine the scoring rules. This typically occurs when the user accepts the default settings, thereby selecting a pre-defined set of rules by which to score the results. For example the Keirsey Temperament Sorter assigns equal weight to all questions answered and predetermines which questions are used to measure particular characteristics. Unless the user instructs the system to score the results in another manner, the system will proceed to step 2300 wherein the data will be scored using the pre-defined scoring rules.

On the other hand, if the user decides to choose his/her own scoring methodology, the system will proceed to step 2120 wherein the database 2130 will be accessed and a menu will be presented to the user allowing him to select a set of scoring rules that differs from the predefined rule set for a particular classification scheme. Alternative scoring options are stored and retrieved from the scoring algorithms database (block 2130).

For example, the Keirsey Temperament Sorter is typically scored with each question being given equal weighing. The totals for each scale are then added and the scores determine the personality classification result. However, in step 2120 the system allows the user to alter the scoring methods using the same questions, i.e., by giving greater weight to certain questions, and by altering the classification schemes using the same questions (i.e., by choosing 10 nodes rather than the normal 16). Once the alternative scoring is selected, the system proceeds to score the data (block 2300).

Once a personality classification model and a corresponding scoring algorithm/methodology are selected, the data collected from Module 1000, is scored at 2300.

For example, if 10 different questions are being asked of a user in order to measure the user's level of Introversion and Extroversion, and on 7 of the 10 questions the user indicates Extroverted qualities, then the system will convert the answer data of the 10 questions into a score of 7 for the Introverted/Extroverted dimension.

The following elements relate to both user and system-selected elements used to score all tests. Elements of all Scoring Systems will include any one or many of the following:

a. Simple Addition

b. Multiplication

c. Division

d. Weighted Averages

i. Based on Correlation Strength

ii. Based on Preference

e. Scaled Scoring based on

i. Degree of Agreement/Disagreement

ii. Degree of Importance

f. Scoring based on similar/same approach used to develop classification scheme

Preferred Embodiment of Personality Model and Scoring

Specifically, the preferred personality model generates 16 personality types that use the following 4 letter combinations to describe the different personality types.

1. ENFP—(Individualistic, unconventional, spontaneous, exuberant, freedom, variety, intuitive)

2. ENFJ—(Enthusiastic group leaders, creative, sincere, articulate, expressive, dramatic, nurturing)

3. INFP—(Ardent idealism, moral, romantic, poetic, selfless, conscience-stricken, adaptable)

4. INFJ—(Poetical, creative, psychic, romantic, loving, sensitive)

5. ENTP—(Curious, pragmatic, innovative, non-conformist, intellectually competitive)

6. ENTJ—(Born leader, take-charge)

7. INTP—(Intelligent, obsessive, even-tempered, autonomy, debate, understanding, shy)

8. INTJ—(Behind the scenes leader)

9. ESTP—(Bold, aggressive, entrepreneurial, charismatic)

10. ESFP—(Life of the party, impulsive, center of attention, Epicurean—pleasure and variety)

11. ISTP—(Adventure, excitement, loners, fraternal, freedom, impulsive)

12. ISFP—(Kind, sympathetic, absorbed, artsy, non-verbal)

13. ESTJ—(Pillars of the community, industrious, conscientious, responsible)

14. ESFJ—(Team player, gregarious, faithful, contributor, people-pleaser)

15. ISTJ—(Dependable, down-to-earth, traditional, dedicated, trustworthy, stable, committed)

16. ISFJ—(Sincerity, seriousness, humility, social ranking, status)

The questions asked consist of 70 questions grouped into 4 separate scales of two letter possibilities creating a total of 16 possible combinations.

Extroversion E . . . I Introversion

Sensation S . . . N INtuition

Thinking T . . . F Feeling

Judging J . . . P Perceiving

Each answer is given the value of 1. The totals are then calculated using simple addition within each question type. For example if 10 questions are answered for the Extroversion/Introversion question type, then the total number of E answers and I answers are summed up. If the user has selected more E answers, then his score will be E. This process is repeated for each scale and the letters derived then the four scales are grouped together.

In addition to the 16 letter combinations, the degree to which the user scored, or was categorized in a particular scale, is represented numerically and presented with the letters to represent relative strength of the scales. (i.e., E-10, S-6, T-7, J-8). These numbers can be the actual number of questions answered for that scale preference or can be normalized to another scale.

Keirsey Character Sorter

The preferred embodiment also includes an alternative where the question types measure 2 letter combinations and/or single letters. In the Keirsey Character Sorter, 16 questions are used to measure the following letter combinations, (NT, SP, SJ, NF). These letter pairs are referred to as Temperaments (Rational, Artisan, Guardian, Idealist). Using another 20 questions, the test determines the letters from two more single letter scales creating 4 variants for each of the 4 Temperaments. The result is to categorize each user into one of 16 letter combinations listed below.

Each answer is given the value of 1. The totals are then calculated using simple addition within each question type. For example, if 10 questions are answered for the Extroversion/Introversion question type, then the total number of E answers and I answers are summed up. If the user has selected more E answers, then his score will be E. This process is repeated for each scale and the letters derived from the three scales are grouped together providing the following 16 letter combinations. The test also uses Keirsey's own descriptions.

Aritisians (SP)—(Practical, Optimistic, Cynical)

The Promoter (ESTP)—(Bold, aggressive, entrepreneurial, charismatic)

The Crafter (ISTP)—(Adventure, excitement, loners, fraternal, freedom, impulsive)

The Performer (ESFP)—(Life of the party, impulsive, center of attention, Epicurean—pleasure and variety)

The Composer (ISFP)—(Kind, sympathetic, absorbed, artsy, non-verbal)

Guardians (SJ)—(Dutiful, Pessimistic, Stoical)

The Supervisor (ESTJ)—(Pillars of the community, industrious, conscientious, responsible)

The Inspector (ISTJ)—(Dependable, down-to-earth, traditional, dedicated, trustworthy, stable, committed)

The Provider (ESFJ)—(Team player, gregarious, faithful, contributor, people-pleaser)

The Protector (ISFJ)—(Sincerity, seriousness, humility, social ranking, status)

Idealists (NF)—(Altruistic, Credulous, Mystical)

The Teacher (ENFJ)—(Enthusiastic group leaders, creative, sincere, articulate, expressive, dramatic, nurturing)

The Counselor (INFJ)—(Poetical, creative, psychic, romantic, loving, sensitive)

The Champion (ENFP)—(Individualistic, unconventional, spontaneous, exuberant, freedom, variety, intuitive)

The Healer (INFP)—(Ardent idealism, moral, romantic, poetic, selfless, conscience-stricken, adaptable)

Rationals (NT)—(Pragmatic, Skeptical, Relativistic)

The Fieldmarshal (ENTJ)—(Born leader, take-charge)

The Mastermind (INTJ)—(Behind the scenes leader)

The Inventor (ENTP)—(Curious, pragmatic, innovative, non-conformist, intellectually competitive)

The Architect (INTP)—(Intelligent, obsessive, even-tempered, autonomy, debate, understanding, shy)

Similar Tests

The preferred embodiment also includes an alternative wherein the text of the test questions is different and/or the number of questions is different, and/or the order of the questions is different, and/or the relative weights given to each answer are different. Each combination will have different correlations to the preferred embodiment but will still result in the 16 letter types listed above.

Referring back to FIG. 7, it will be remembered that the Select Classification Algorithm, step 2400, uses the selected personality model(s), and scores received, and data collected from Module 1000 to determine the type of classification algorithm to use in categorizing users. In cases where there is a single personality model, the classification of the user is the same as the result received from block 2300. However, since the system is able to recognize certain question and test combinations and is able to access the database 2500 to retrieve a corresponding classification scheme, if multiple models are used, step 2400 will further categorize the user by using a model to incorporate many personality, psychographic, demographic, and behavioral models.

For example, where a user would like to know his/her financial personality, use of the Keirsey Temperament Sorter together with other personality models and other data gathered from module 1000 would allow the system to further classify the user to measure personality dimensions such as risk aversion, anxiety, contentment, and altruism. Such personality dimensions are not best measured by the Keirsey Temperament Sorter and may not have Financial Personality implications by themselves. However, when combined with the Keirsey Temperament Sorter or any other test, a new categorization scale is created.

The algorithm selected at 2400 can also take behavior and action information from module 1000 and convert it into a standardized format. For example, the system analyzes the users stock trading history and then converts the history into a series of alpha numeric scores that represent the size of the trades, the frequency of the trades, and the holding period. These numbers are used alone or with other data gathered to score the dimensions used for financial personality type and may indicate that the user is a day trader. Similarly, the system analyzes purchase history in order to categorize users.

Example Financial Personality Types

Clan Financier

Heedful

Nonconformist

Incognito

Competitor

Aristocrat

Treasurer

Experimenter

Intellectual

Some of the Characteristics used to measure the above Personalities

Participation

Anxiety

Power

Risk Taking

Trust

Control

Knowledge

For example, answer patterns indicating low trust, high risk tolerance, power seeking, moderately knowledgeable to investments with an “Artisan” personality would be consistent with the pattern of a Power Investor. Answer patterns indicating high level of fear, little investment knowledge, delegation of investment decisions, low risk tolerance and a “Guardian” personality type will match up with the Heedful Investor.

Regarding dating and career choices, different dimensions of character may likewise be measured to identify profiles and to deliver advice and content to the user. Furthermore, the Keirsey Temperament Sorter may be provided as a foundation to determine a relationship preference for singles. Additional questions when added to the Keirsey Test (or any other test), will produce a new classification scheme that can be used to provide relationship advice, matching content, and or offer services and products.

Once the classification algorithm has been chosen, then at step 2600 the system compares the user's scores and results from step 2300 and step 2400 against the classification scheme(s) chosen from database 2500. The system then determines the closest match and selects and presents the classification to the user. For example, a user taking the Keirsey Temperament Sorter scores 7 on the E scale, 8 on the S scale, 9 on the F scale, and 10 on the P scale. These scores will be compared to the all of the classification possibilities and matched with the closest one. In this case the user will be classified as an ESFP. This user might also be classified as a day-trader.

Module 3000—Content Matching

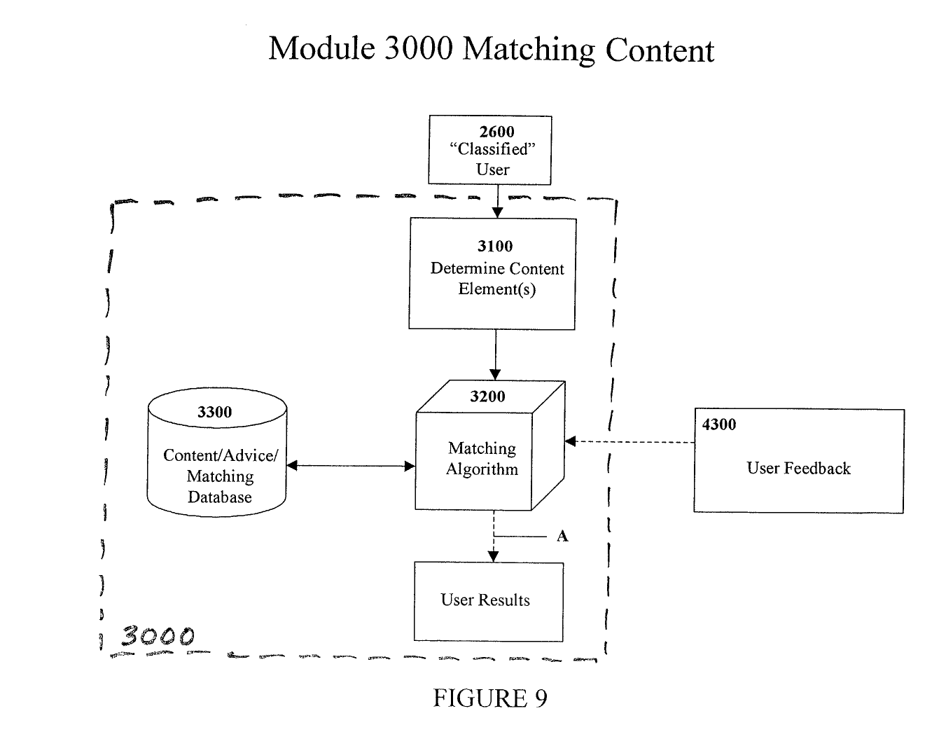

One of the most unique aspects of the present invention is its ability to match content, advice, and people based upon the data provided from Module 1000 and the classifications determined from Module 2000. As depicted in FIG. 9, the system matching starts by determining at 3100 which content is to be analyzed for matching and which algorithms are to be used at 3200 on the selected content. Once determined, the algorithms provide the system with a rule framework upon which decisions are made and content selected from Database 3300. The algorithms select the content that is displayed/presented to the user. The system also allows for dynamic and static improvements to the matching algorithms by incorporating user feedback, observed behavior, and outside inputs to continuously modify the accuracy and relevance of the content presented. The system is not limited to matching only on classifications but can also match based on a single trait or characteristic.

Once the user has been classified, the system determines at 3100 which content to present based upon the context of the users session, product or service request and the personality classification from module 2000. For example, a user takes the Keirsey Temperament Sorter and is classified as an ENFP. Content relating to the ENFP personality type is then displayed for the user. The user may also purchase more detailed descriptive reports.

The 3 main categories of content elements are People, Advice, and Content. The combination of elements is determined based upon the product or service being delivered to the user. The services can either be free or for fee, and can either be purchased by the user or by someone else for the user.

The system operates on the premise that two users with similar answer patterns and/or behaviors, will exhibit similar behavior, have similar preferences and find similar advice useful.

The Matching Algorithms at 3200 determine which content will be displayed to the user and how the content should be delivered and displayed. As object 3100 explains the context to object 3200, object 3200 uses matching algorithms to select the content, advice and people matching criteria within the context in which this information is being sought.

For example, if a user wishes to purchase advice on how to relate with co-workers, then content elements determined at 3100 tell the system at 3200 which content to select from and which matching algorithms to use for the matching. There are 3 main matching algorithm categories designed to determine and deliver the most appropriate and most relevant content to the user. There are the Content Algorithms, the Advice Algorithms, and the People Algorithms. One or more algorithms may be used and combined during a content match.

Within database 3300, all of this content is stored and each element is recorded with a relative relevance strength indicator. A strength indicator value is stored in database 3300 for each node for each classification scheme available. The value is determined based upon 2 groups of factors. The first is the user's personal data, history and declared preferences and the second is the systems understanding of preference and relevance from users having similar classifications. For example, the system knows that fantasy stories and articles about the environment appeal more to Keirsey's “Idealist” personality types. The relevance values recorded and saved for Idealists will be relatively higher than for Keirsey's other Temperaments (Guardians, Rationals, Artisans). As new users are classified as Idealists, then the system will use the Idealist values for relevance, and present more fantasy stories or environment-related articles to these users. As the system of the present invention receives feedback from Idealist users, reliance values may be increased or decreased to reflect the interest of all Idealists. This allows the system to learn and improve the accuracy of the relevance values over time.

The relevance values are not limited to personality but extend to other traits as well. For example, the criteria may be political views. If so, then relevance scores will be determined based upon political views rather than on personality model.

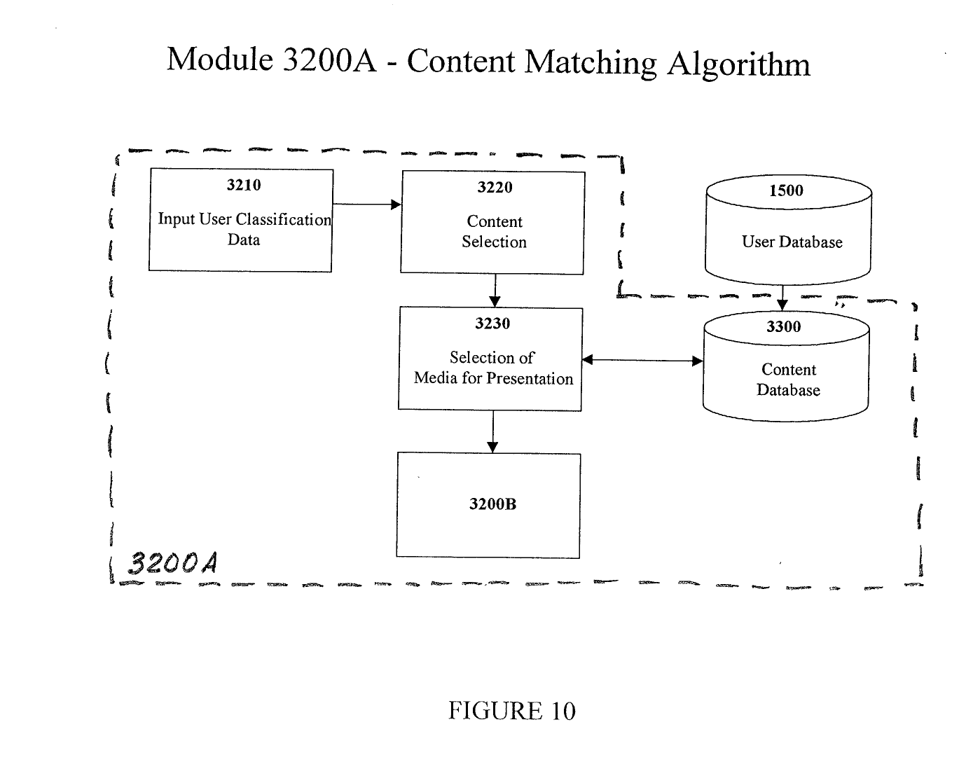

As illustrated in FIG. 10, module 3200A includes Content Matching Algorithms designed to provide customized and personalized content based upon the data collected in module 1000 and classified in Module 2000. All of the content in the database have “strength of preference” or relative preference scores associated with the classification models in Module 2000. These relative preference scores are stored in the database 3300 with the content. The preference for certain content presented to users, is measured by the amount of time spent viewing pages, the subject of the pages viewed, the total pages viewed, the user's purchase history, partner type from which user was referred, offers responded to, click-stream data, declared preferences, external inputs from other systems, offers signed up for and updates in a user's information and classification. This measurement occurs in real time.

Module 3200A begins with step 3210 where the system asks for input from the user for the classification scheme and the node to use for matching content. In most cases, the scheme and node will be provided by the system as the most recently assigned classification from Module 2000. However, the user will also be able to simply input a node result directly into 3210. This input option will be available for those that may already know their classifications although no record of this classification exists in the inventions database. These inputs will also be utilized by the invention in Modules 3200B and 3200C.

For example, a case in which the user has just taken the Keirsey Temperament Sorter and has been classified as a Rational Fieldmarshal ENTJ. The system uses the Keirsey Temperament Sorter classification scheme and the Rational Fieldmarshal ENTJ node (along with the actual scale scores) and proceeds to step 3220. Alternatively, the user may have simply selected the Keirsey Temperament Sorter and entered the ENTJ node along with strength values directly to proceed to step 3220. This information will also be used in 3200B and 3200C.

Step 3220 is the process by which content is selected for the user. In this step, the system gathers information from database 1500 such as declared preferences, purchase history, page view history, and click history of the individual, and compares this with the personality, psychographic, behavior, and declared preference relevance values from all users to determine the optimum content to display to the user.

Content selected in step 3220 includes, but is not limited to, raw scores on each scale, graphical representations of the scores, the title of the node or classification, and descriptive text of the user's personality classification.

Content selected may also include stories, news, articles, and information that other ENFP have found interesting.

Product Service Ads Elements

Based upon data gathered in Module 1000, and the classifications made in Module 2000. the system can construct and/or deliver promotions and advertisements in real time. This is used when the user views a page with ads, or the system delivers promotional materials via email or other electronic means. This information together with the rest of the user's profile is compared to all available content and is used to select the subject matter, the layout, and style of the promotional material. Either a pre-existing ad is selected for the user or one is constructed in real time. For each ad that is deployed, all components that made up the ad are recorded.

For example, graphics used, colors, sounds, and multimedia portions text, font, layout, format, timing and all other components are recorded. Each element is tested and changed using a champion/challenger system designed to choose the elements that drive the highest click-through and conversion rates for each of the classification types.

This object also has a matching algorithm to match the content and the type of product/service being advertised with the user classifications that would most prefer such an offer. For example, just as the ENFP has preferences with text content listed above, the ENFP and/or the specific user will have certain preferences for products and services that are shared by most ENFP. The system presents advertisements and offers to this user based on the user's ENFP classification and based upon specific individual data gathered in Module 1000. This content presentation can occur in any web page format, banner ads, email, and sponsor links.

Color, Font, Layout Elements

The system can also construct page layouts according to the user's classification including color, font, use of graphics, and presentation of data, video and audio content. All potential elements on the web page are recorded with a relative preference code to give the system a basis for selecting the elements for a particular classification. For example, the system determines that the “ENFP” classification prefers to see new product announcements on the left side of the page using a particular shade of blue. So for each new person that is classified as an “ENFP”, the initial location of new product announcements will be displayed on the left side of the page in that shade of blue.

Module 3200B—Advice Matching Algorithms

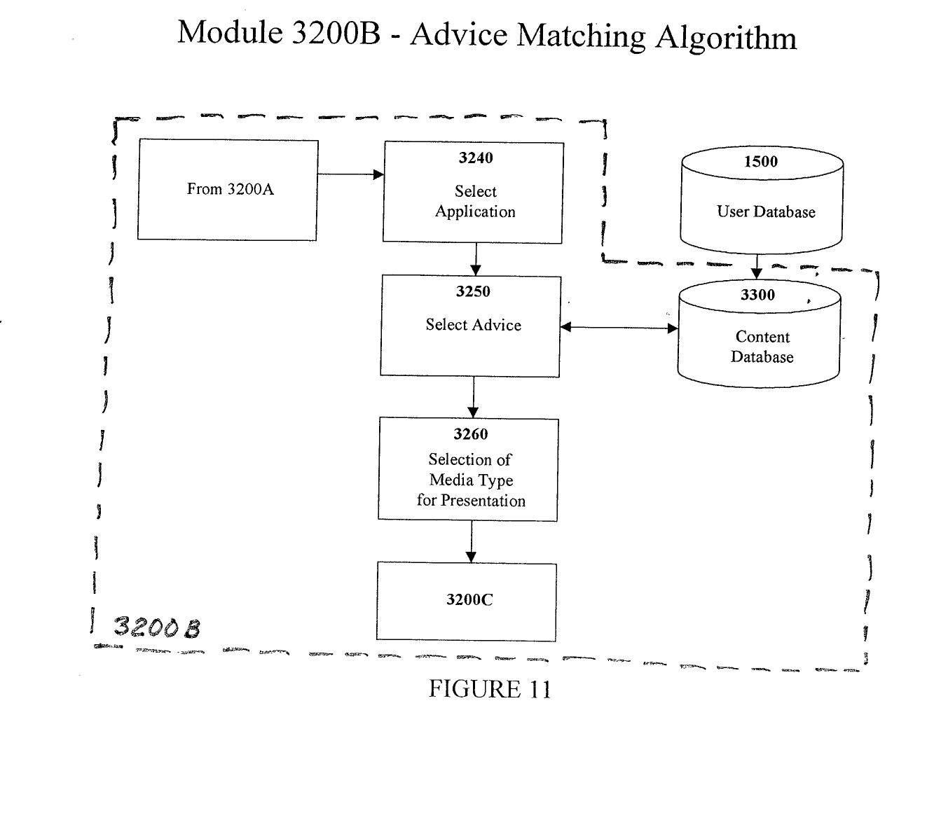

Referring now to FIG. 11, the advice module 3200B is depicted. This module is designed to offer personalized advice to users based upon personality, psychographics, demographics, behavior, declared preferences and any other data gathered in Module 1000 and 2000. In the preferred embodiment, the system will provide career related advice, relationship related advice and financial related advice. Advice provided in this module differs from content (provided in 3200A) in that it is information that the user is actively seeking. Content is passively presented to the user based upon relevance values, history, and declared preferences.

The process begins at step 3240 where the system must determine the application for the advice. In other words, what type of advice is the user requesting, and for which classification scheme should the invention provide advice. At this step, the user is presented with a menu of choices for advice subjects (i.e. career advice, relationship advice or financial advice), classification schemes (Keirsey Temperament Sorter, Enneagram, Skills Tests, IQ Tests etc.) and specific topics (i.e. “What job am I best suited for?” or “Which types of people am I best suited for?”)

For example, the user may select advice for the application of “Career.” The user or the system then selects the classification scheme within which this career advice will be provided In this example, the system uses the Keirsey Temperament Sorter personality classifications since the user just tested as a Rational Fieldmarshal ENTJ (however, the user may have the option to change this condition). The user then selects the specific topic for the advice (i.e. “how to better communicate with my boss”). Step 3240 may also require that additional information be provided; such as the boss' personality type. The user then submits the information and selected choices, and proceeds to step 3250.

At step 3250, the system searches the database 3300, for the appropriate advice on how the user should communicate with his/her boss. Thesystem uses the classification scheme selected, and additional information provided in step 3240, to determine the most relevant advice. The system also uses data available and additional data from user database 1500 to determine which advice should be presented.

For example, the system will use the user's classification Rational Fieldmarshal ENTJ and info input on boss from step 3240. However, the system may also use other data from the user's records from object 1500; such as gender, age, political views, or any other data gathered in module 1000, to further refine and produce improved customized advice for the user.

In another example, the user is looking for specific advice for relationships. The user (an ENTJ) would like to know how compatible he/she is with another user (an ISFP). The system will take the inputs from 3240 and from 3200A and will compare the personality types by discussing both the pros and cons for a pairing of those 2 types. In the preferred embodiment, the invention will also provide the user with a “percentage of compatibility” number that corresponds to the likelihood that the 2 types are compatible and specifically break down the areas of conflicts and agreement for those two types.

Like content in 3200A, all advice stored in database 3300 has relative relevant strength values associated with every classification scheme. In other words, for the Keirsey Temperament Sorter personality scheme, a relevance value for all advice provides the system with a way to select the most appropriate advice. This same advice could be used in the Enneagram scheme with relevance scores for each node of this scheme.

Once the “best” advice match is complete, the system proceeds to step 3260. In step 3260, the system determines the best media format to use in presenting the results. In the preferred embodiment, the system will use text to provide advice. However, the user may wish to receive this advice in the form of a video or audio clip or stream. In step 3260 the user will have the ability to select among a number a media options.

The advice matching feature 3200B is not limited to any specific topic nor to any application. The user may make the request to get advice on “how to interview”, “how to better communicate with your employees” or “how to manage your investments” or may choose dating advice, general relationship advice, learning styles advice, and service and product recommendations, corporate development, change management, executive development, talent management, enumeration advice, and talent acquisition advice, job fulfillment, military functions, sales strategies, communication with others, team building.

Module 3200C People Algorithms

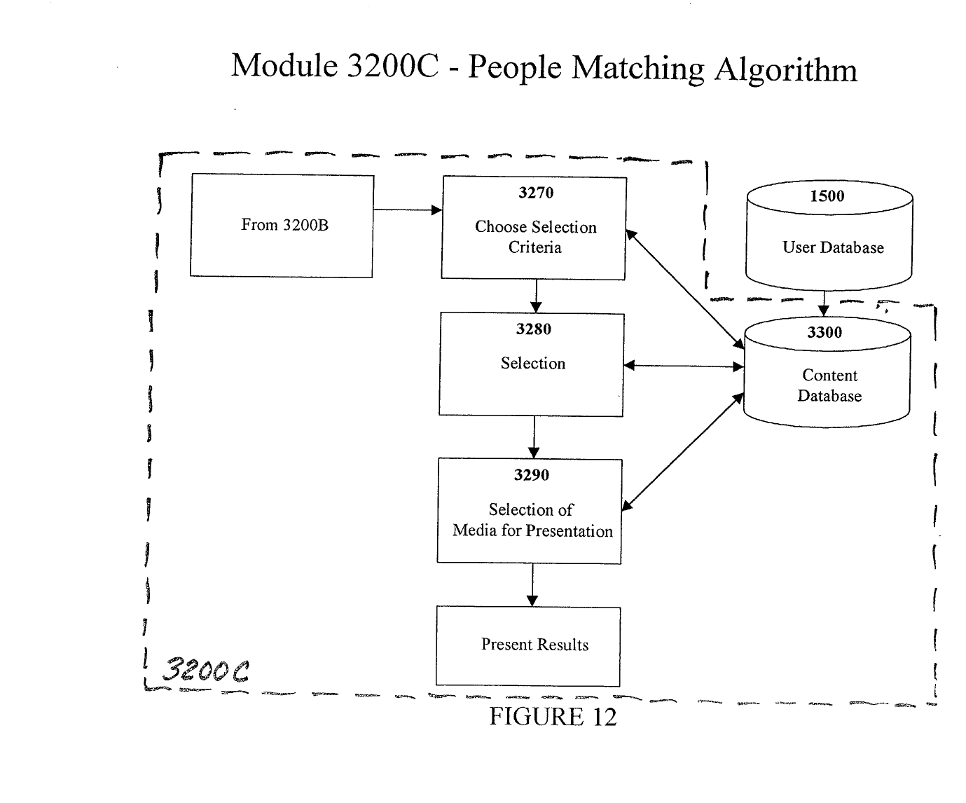

As shown in FIG. 12, the people algorithms differ from content and advice in that they rely on a database of users that possess classifications and scores obtained using similar or a common classification scheme. Whereas block 3200B will provide advice on “how to better communicate” or may tell one which classifications he might “do best” with, the people algorithms (block 3200C) will find those users that possess the desired classification or characteristics.

At step 3270, the user is asked to provide criteria as to the characteristics that the system should use to obtain a match. If the user's request for a match is general in nature (i.e. “a compatibility match” or a “good match”) then the system will find people using predefined matching rules. The matching process in this case uses all information from the user database 1500 to help determine the most appropriate match. (i.e., in a generalized search, the system could use any information that was collect in Module 1000; such as psychographics, personality, demographics, behavioral, and declared interests).

In a “specific search”, if the user wishes to choose from a menu of characteristics for the system to search on, then he would do so at step 3270. Here the system would retrieve all possible criteria (from database 3300) on which it can search, and present the user with a choice as to how much of each level of each characteristic the system should use to search. The user would then be presented with text boxes, radio buttons, or a graphic sliding scale, etc., to indicate how much of each specific characteristic he wishes to find in a person. The user is then asked to provide and submit this information.

Once the user submits the traits he/she wishes to locate in the database, the system proceeds to step 3280 to select potential matching users from database 1500 (or from a third party database outside the system).

In step 3280, the system will provide for the matching of classified users with other users who possess either similar or different classifications or characteristics for both specific and generalized searches. If the user request had been simply to find the “best match”, the system would match people based upon the closeness of measured characteristics. The matching would occur using a weighting scheme for all possible characteristics giving more weight and importance to certain characteristics. For example, in a generalized search, one algorithm matches people on the closest match to the classification used. If an ENFP is looking for other ENFPs, the algorithm will find a list of user classifications that most closely match that of the user.

Person 1: ENFP

Person 2: ENFP

Person 3: ISTP

Person 4: ISFP

Person 5: INTJ

In this case, persons 1 and 2 would be selected as the closest match and person 4 would be the next closest match.

A second algorithm utilized by the system for generalized searches matches people based upon the relative strengths on the scales within a classification model. The following five user scores for the E and I scales illustrate this example. Out of a total of 10 questions, the following shows the answers chosen for the E and I preferences.

Person 1: E=6, I=4

Person 2: E=10, I=0

Person 3: E=5, I=5

Person 4: E=4, I=6

Person 5: E=3, I=7

In the first people-matching algorithm, the person 2 would have matched the closest with person 1 since they both tested as ENFP's. However, in the second algorithm, person 3 and 4 actually scored closer to person 1 than did person 2. Although persons 1 and 2 both have a preference for E, person one's preference is not so strong and is actually closer to person 4 by 2 questions. The process is repeated for each of the 4 scales. This algorithm seeks the closest match with the entire letter types giving preferences to the N/S scale should there be a tie. The matched users are then placed in order of match criteria and presented to the user.

The system also incorporates variations to the above algorithms based on different weighting of answers, different weighting of scales, and incorporation of other models and all data gathered in module 1000.

For specific searches, the predefined rules would be bypassed in favor of any selected preferences provided by user in 3270. For example, the user may wish to find someone that is Extroverted (E=6), that uses feeling more than thinking (F=10), that thinks abstractly (N=8), and that has good organizational skills (J=9). The system would then search the user database 1500 to find all of the people with these same and/or similar scores within the same classification scheme.

Once the list of matches has been generated, the system proceeds to step 3290 where the information is presented to the user. The purpose of this step is to provide the system with the ability to display the match results in the form of text, audio, video or any other media format. For example, the list of users may include audio or video clips of the people within the database. If the system were used in the dating service role, the person in the database may wish to store video or audio clips of them, or of anything else. This information would be presented as part of the people search results in step 3290. Similarly, in the case of an employer using the system to find new job applicants, the system will enable the user to present video or audio as part of their search results. In all cases, the user will have the ability to select the conditions under which particular components will be presented.

The people matching feature 3200C is not limited to any specific application. The user may also make the request to simply find the best suited, or least suited, people for either a job position, friendship, or date. In each of these different applications, the system will offer a list of characteristics from which the user may make selections.

For example, the system can be used to find/match people based upon a selection of personality traits, skills, competencies, attitudes, beliefs, behaviors, psychographic, demographic and resume items. An employer may wish to search the database based upon personality type, or specific characteristics, to find people that are best suited for a particular job. The system can also be used to find people with particular skills or competencies, or other characteristics that are best suited for a job. Additional personality tests, or skills tests, or competency models/tests can also be used instead of the Keirsey Temperament Sorter. The uses for this include but are not limited to job matching, dating matching, and friendship matching.

Module 4000—Automated Algorithm Updates

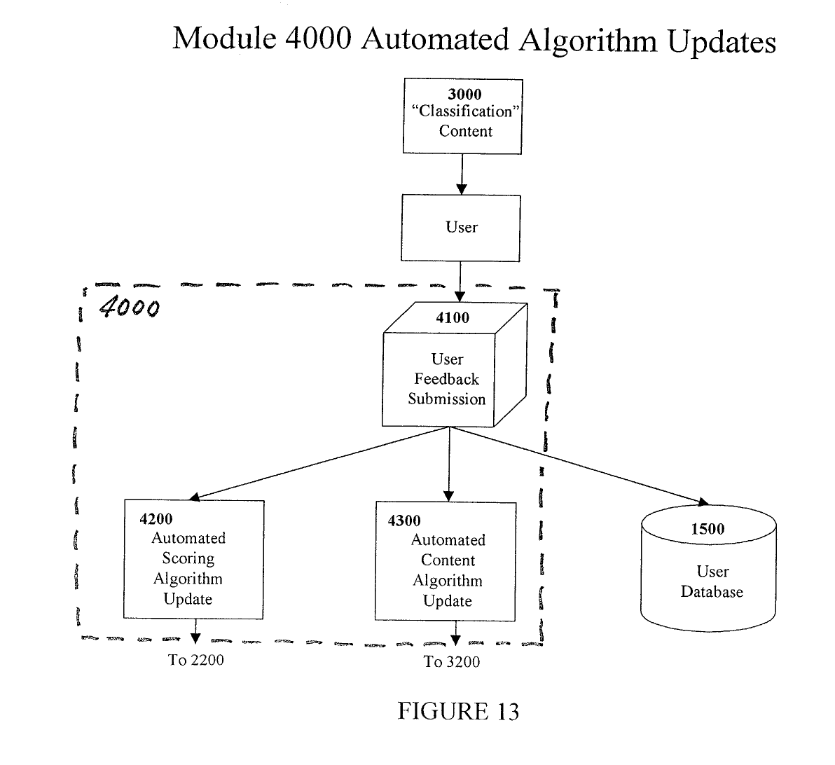

FIG. 13 is a diagram illustrating how the system uses user feedback to improve the accuracy of the matching of content Whereas the classifications are determined based upon a set of scoring and sorting rules, and whereas the matching of elements is based upon individual preferences and on classification preferences, the system allows for internal feedback to improve classification accuracy and to improve the accuracy of matching users with elements The feedback is used to alter the scoring rules in Module 2000 and the relevance strength values used in Module 3000.

When classifying users in block 2000, the system compares a user's testing feedback and data record (block 1500), to categorize the user according to a classification scheme. Each classification scheme has a set of rules by which answer scoring and classification decision are make. Block 4000 provides a dynamic feature for modifying the scoring and classification rules based upon the user's feedback. This feedback can be in the form of test questions, text boxes, or any other method used to convey opinions of the user. This feedback is then used to modify the scoring and classification rules for the classification scheme and in other words, improve its accuracy. Adjustments to the modules are not limited to the system's automated process. A person may do the adjustments after analyzing the data provided.

### EXAMPLE 1

The user tests as an Idealist Champion ENFP. The user finishes the Keirsey Temperament Sorter and is then presented with descriptive content regarding his/her personality type. He/she is asked to respond to the accuracy of the description and/or scores of the scales used to classify. The user may also be asked to provide his/her thoughts regarding which classification or description is a better fit for him/her, or to provide text that describes him/her. This feedback is then used to modify the scoring of all the testing elements used to determine that classification. If the feedback is positive, or the classification was “accurate”, then other users that have similar answer patterns or responses will more likely be classified as Idealist Champion ENFPs.

The system uses user feedback (both declared and observed) to update the matching algorithm in module 3000. As users receive content and advice, and are matched with other people, the system allows the users to provide feedback regarding the accuracy, relevance, and interest level for the matched elements presented to them. Like the example above, this could be in the form of declared feedback from questionnaires or forms, or it may be in the form of observations of user click history. Since the system uses relevance strength values to match elements with the user, this feedback will be used to alter these values to improve the accuracy of the matching algorithms of modules 3200A, 3200B, and 3200C. Adjustments to the modules are not limited to the system's automated process; a person may do the adjustments after analyzing the data provided.

Continuing the use of Example 1, the same user is also presented with articles on the environment and an advertisement for a new Astrology Service. The system measures the user's click history (including but not limited to where he/she visits, how much time is spent per page, and which ad was clicked), and sales conversion rates for the proposed product. The user reads the article and also subscribes to the Astrology service. The system then records these actions in the user database and alters the relevance strength values for the Astrology service and the environment article, meaning that these two elements will relatively more likely be presented to other Idealist Champion ENFPs than to users with no classification. This content will also be relatively more likely than other content to be presented to Idealist Champion ENFPs.

### EXAMPLE 2

User wishes to participate in a research study. The user provides personality data and any other data potentially asked for in module 1000. The user is then asked specific questions that relate to a product or service. These questions include, but are not limited to, history of use, knowledge of, possible interest in, interest level, propensity to purchase, why they would buy or subscribe to a service, why they buy or use similar products and services, etc. The system then uses the research feedback to alter the matching rules in algorithms 3200A, 3200B, and 3200C.

### EXAMPLE 3

Same as example 2, but the user is participating in a research project that may involve non-product and service concept such as linking personality type with behavior, attitudes, learning styles, psychographics and preferences or other concepts. The feedback is then used to modify the relevance strength values used to make matches between users and content or advice, or people.

### EXAMPLE 4

A user is interested in finding a compatible person to date. The system provides the best suited people based on his/her classification, the user then provides feedback regarding the success of the match. This feedback could include specific reasons why it did or did not work out for the user. The feedback is then incorporated into Module 3000 altering the matching algorithm for the next use. If the feedback had been poor, then future matches for people with similar answer pattern and data records would be less likely in the future to match these two user classifications.

### EXAMPLE 5

Similar to example 4 but the user is seeking to fulfill a job opening. The users in the database possess particular skills, competencies and personality traits, and the user determines which skills, competencies and personality traits are required for the position. The system provides a match, and the user is asked (when he/she has had time to evaluate the match) for feedback in the form of detailed information as to why the match did or did not work out. This information is then incorporated into Module 3000 and used to modify the rules used in the people-matching algorithm. If the feedback had been positive, then future matches for people with similar answer pattern and data records would be more likely in the future to be matched with job positions having same and/or similar requirements.

Upon receiving content from the system (i.e. content, advice, people matching), the user is asked for feedback as to how interesting, accurate and relevant the content was to him or her. Step 4100 provides for the user to enter the feedback into either a series of questions, text boxes or any other method that would convey the opinions of the user. The invention then updates the scoring methodology in 2200 and the matching relevance values used in block 3000, and stores the information in user database 1500.

Upon submission of the feedback, the system proceeds to step 4200. Here the accuracy feedback from the classifications will be used to alter the weights placed on particular questions, groups of questions, answers, or tests. Upon submission, the system also proceeds to step 4300 where feedback from step 4100 is used to alter the relevance scores for all content as it relates to a particular classification scheme. For example, if an ENFP is presented an article, and the feedback is quite negative, the relevance score for the ENFP drops. Over time, the aggregated feedback from many ENFP users will alter the relevance score so that the system will more accurately predict which content is most preferred by ENFPs. The updated relevance numbers are sent to step 3200. All feedback provided by users is saved under their unique id in the user database 1500.

For example, the system can be used to find/match people based upon a selection of personality traits, skills, competencies, attitudes, beliefs, behaviors, psychographic, demographic and resume items. An employer may wish to search the database based upon personality type or specific characteristics to find people that are best suited for a particular job. The system could be used to find people with particulars skill or competencies or other characteristics that are best suited for a job. Additional personality tests or skills tests, competency models/tests could be used instead of the Keirsey Temperament Sorter. The uses for this include but are not limited to job matching, date matching, and friendship matching.

Group Testing System

As described up to this point, the subject method and system has related to use thereof by an individual. However, another version of the system allows for the administration and testing of groups.

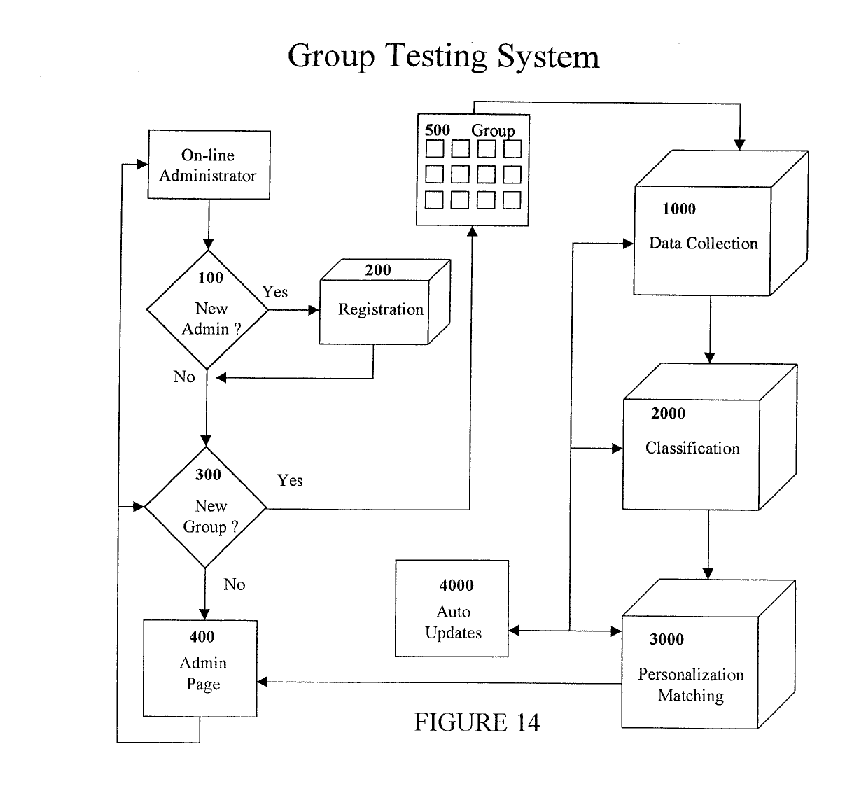

The system's group testing process is illustrated in FIG. 14 and is similar to the process depicted above in FIG. 2. However, in the group version, the system allows for much greater flexibility in determining the key steps in the process. Moreover, an administrator is the single user that prepares the system to test a particular group

As in the above described individual user process the group process begins with a log in function at step 100 wherein the system requires an existing administrator to log into the system and a new administrator to register by answering a series of questions (step 200) including demographic data, contact information, type of group, industry, use of the group testing, and proposed login Id and password. This will create a unique Id for the administrator that will form a new data record in database 1500 and will be unique for that administrator.

The administrator then proceeds to step 400 where he/she is able to set up testing for new groups or more testing for existing groups. For new groups, he/she is able to determine several aspects of the group testing process; such as the number of tests takers, the number of tests, the type of tests, information on each of the individuals such as name, email, address, title, unique number etc., whether or not the user will have access to the results, whether or not to give the user the option of not providing his or her results to the administrator. The administrator can also pay for the services and products at step 400.

The administrator will also be able to determine details regarding the testing process in each of the three major Modules (1000, 2000 and 3000).

For Module 1000, the system will provide the administrator with a menu of question types, media formats, and an interface by which he may design a form to include his/her own unique questions. For step 1100 the administrator will be able to determine which testing elements are to be displayed and the media format of the elements. He/she will also be able to determine the presentation type for module 1300B (i.e. Random (1350), Rotation (1360), conditional (1370), or a combination thereof (1380).

For Module 2000, the administrator will be allowed to select the scoring options and presentation options as described in step 2120. Classification occurs at both the individual level and the group level. The administrator will also have the ability to use customized scoring methods, select customize classification schemes or predefined ones.

For Module 3000, the administrator will be able to select the content elements as described in step 3100, select the type of content to be presented (3220), and the media format of the content (3230). The administrator will provide whether the detail for the advice to be matched (i.e. the subject matter, content (3250), application (3240) and the media format (3260) is to present the content. The administrator will also be able to customize the relevance values to alter the matching algorithms to meet his/her needs.

Module 3000 provides for matching of elements at the individual level and at the group level.

All settings provided by the administrator are saved in database 1500 and take effect for all individuals that enter the system from the group.

Once all members of the group have completed the testing, the administrator is notified and may view the results on his/her administration page.

### EXAMPLE 1

Administrator registers as a new administrator and provides the required information to obtain a unique password and Id. The administrator decides he/she would like to purchase 1000 Keirsey Temperament Sorter tests for his company. He provides the demographic information on each of the individuals and submits the company credit card information for payment. The system generates the unique passwords and login Ids for the 1000 users that are then delivered. The administrator uses the custom interface to design a custom demographics page form to allow him to also ask custom questions relating to an employee's department, title, branch, division, city and country. The administrator may decide to exclude certain questions from the Keirsey test and offer a 35 question version of the original 70 question test. The administrator may decide to change the scoring and classification scheme to categorize people into just 4 nodes using the four Keirsey Temperaments (Rational, Artisan, Guardian, Idealist). All users are given the ability to opt-out from any group reporting or disclosure of their information to the administrator.

The users then proceed individually through the system as described above with the exception that the system uses the settings provided by the administrator. Once all of the individuals have finished their testing, the administrator can view the results via a series of reports designed to provide summary information for the group, and he can provide advice for the group. The group advice in this example is for corporate team building. The details of the team as a whole, including the aggregate traits of all the individuals that make up the team, are presented and provided to the administrator in the administrator page. The system will offer advice for improving team communication and greater understanding among the individuals and co-workers.

### EXAMPLE 2

A university professor wishes to test his/her classroom of students to determine learning style preference. The system steps are the same as in Example 1 except that the administrator selects a different application for the group results. Instead of a team building application (and subsequent matching of team building related content to the individuals and the administrator), the content and advice matching algorithms are set to match according to learning styles and other educational topics.

### EXAMPLE 3

Same as Example 1 except that the administrator wishes to conduct research on a group using personality type. The administrator will determine whether or not the research results will be presented to the users upon completion. The administrator will choose a behavior test exercise. He/she will also choose a number of custom questions that relate to the research project that will be added to any testing done by the system. He/she will also choose video format. The testing requires that each user response to situations via a series of video clips. After each clip, the user is asked to respond. Each member of the group will complete his/her test and both the individual and the group results will be tallied and presented to the administrator at the administrator page.

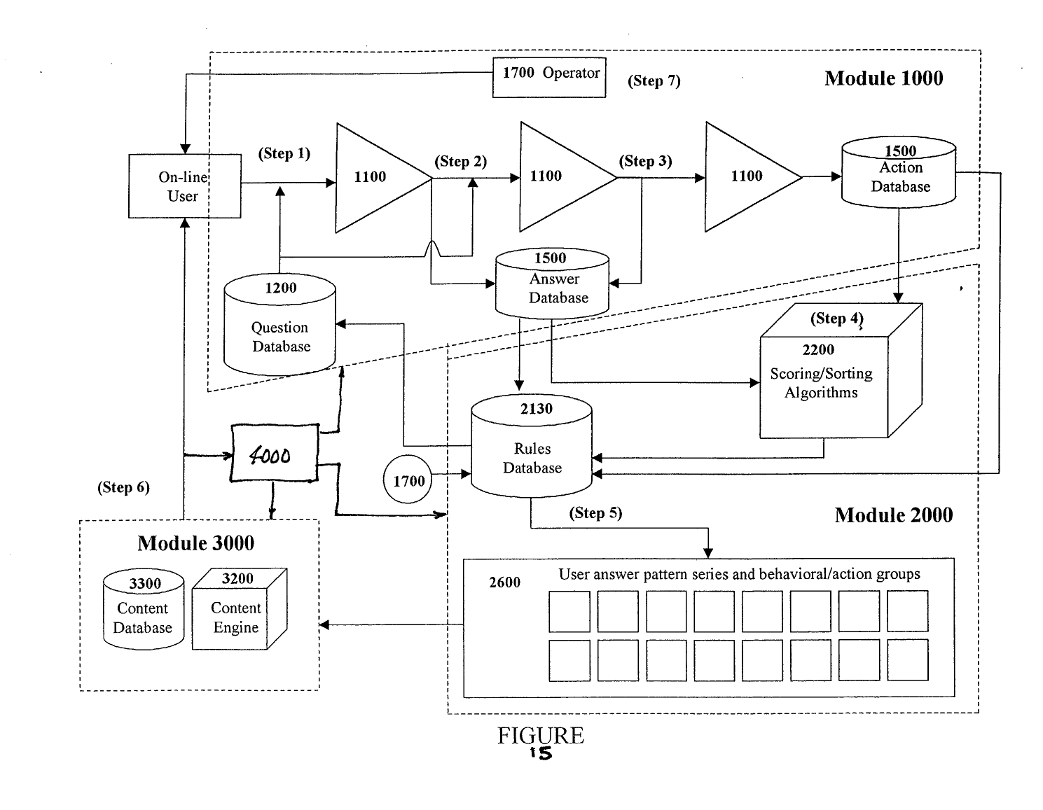

The system described above can have many variations. One such variation is illustrated in FIG. 15 and described in the following:

Module 1000

Step 1

User goes to applicant's website, logs on and/or registers and is presented with an offer to take a personality profile test and is provided with a description of the test (step 1100). Once the user decides to take the test, he is presented with a series of questions obtained from a database. For the user with no answer history in the database, the questions consist of the Keirsey Temperament Sorter or the Keirsey Character Sorter (a general personality/temperament test). The user's answers are collected and stored in a database and an account is created for the user including a user Id and password. Every answer to every question is stored in a database. If the database already contains this information for the user, the user proceeds to step 2. After providing answers to the Keirsey test, the answers are stored in database 1500 and the user proceeds to the next phase of step 1100.

Step 2

This phase is for the user who has already taken the general personality tests. The user is presented with additional questions. The presented questions include one or more of the following question types: (a) Demographic (b) Declared product/service preferences (c) application specific psychographic (d) situational behavior and/or (e) a combination of the foregoing. These questions could be financial related, career related, human relationships related, education related, commerce related. The user's answers are stored in a database under the account created previously by the user. Each time the user returns and answers more questions, the answers are recorded in the user's account. The system recognizes which information the user has already provided in order to prevent redundant questioning. In addition, the system gathers information on the user's computer and browser to determine the best method of conveying content. Upon completion of this information-gathering step, the users answers are recorded into user database 1500 and the user proceeds to the next phase of step 1100.

Step 3

This phase differs from the first two in that question elements are used. In other words, interactive testing or role-playing or any other testing that requires the user to respond in some sort of actionable way. Behavior also includes actions observed or input into the system. The user's observed action and behavior is recorded with the rest of the users answer information (user database 1500). This information consists of a combination and offline inputs of observations of behavior by a service provider such as previous actions taken by the user and online click stream information such as purchase history, page view history, advertisement click through history and click history. This information is gathered by observing the user's actions on the proprietor's website and from user behavior information or inputs from third parties at 1700. For example, a stockbroker using the system may wish to add stock-trading history into the data collected or a retail business may wish to enter the offline purchase history of the user. In both of these examples, the system will store the information as part of the user's profile.

Actions measured also include situational behavior. For example, the user is presented with video content of a situation and the user is required to react in some manner. How the user reacts is stored in the database and used in conjunction with the data collected in steps one and two. A specific example may include a user being tested for how he/she would react in a situation where a burglar has entered their home and pulls a gun out. The user will have to pick one of the options: (1) negotiate with burglar (2) run, (3) shoot. The answers are also stored into the user's profile.

Once the user has progressed through all three modules and provided the requested information, the user proceeds to Module 2000 in order to score his/her results.

Module 2000

Step 4.

In this step, the system takes the data that was collected in Module 1000, classifies the user. First, a classification scheme is chosen 2100 (FIG. 7). Then each user's answers and actions are scored and compiled by algorithms into answer patterns and behavioral/action groups according to the chosen classification scheme. This step 2300 (FIG. 7) standardizes the data so that the user profile can be compared to others using the same classification scheme.

The classifications are then compared to a Rules Database (2130). Based upon the answer patterns in step one and step two and upon the behavioral/action information from step three, the system uses rules to cross reference and match similar answer patterns and behaviors stored in databases (2600).

For example, the stock trading history is entered into the system. The behavior exhibited by the individual while trading indicates that certain cognitive errors are keeping him from making better trading decisions such as holding on to a losing position too long or selling a winning stock to early. The history also reveals that the user is only interested in certain industries. Observation of user click history indicates the research reports, articles and ad that have been clicked. Based on this observed behavior, recommendations to improve the users trading. The system also notes which articles and research reports interested the user suggests that other like him also see the same reports and articles.

Behavior from situational video is used to categorize individuals as well. This categorization may be into a general personality type or in an application. In the example of the burglar, choosing to negotiate may indicate a profile that the police academy is looking for.

Module 3000

The system operates on the premise that two users with similar answer patterns and/or behavioral/action groups, will exhibit similar behavior, have similar preferences and find similar advice useful.

For each defined answer pattern and behavioral/action groups in the rules database, a variety of targeted content is maintained. Once the system has matched up a user's answer patterns with answer patterns in the rules database (3200), the system accesses a series of content databases (3300). The appropriate content is then delivered to the user.

The system keeps track of user specific preferences, i.e., financial preferences, dating/mating preferences, career preferences, education preferences, merchandise buying preferences, and any other application specific information. It also tracks presentation preferences such as content layout and ad content. The preferences are tracked by observing click stream data and from declared preference. This information is used to fine tune the content actually preferred by the user and is added to the rules database.

Module 4000

The rules database contains aggregate information of many people on “the most likely” preferences for those individuals possessing certain traits or personalities. Each user is initially presented with “the most likely” preferred content. As each user provides more information to the system through step one, two, and three, targeted content is further fined tuned. These inputs are added to the rules database and could change the “most likely” preferences. Continually adding current preference information into the rules database, improves the systems view of “the most likely” preference for others with similar characteristics. This continuous feedback loop increases the system's accuracy in providing preferred individualized content.

What is claimed:

1. A method for determining certain personal characteristics and preferences of an individual, comprising the steps of:
subjecting the individual to one or more personality tests and recording the results in a database;
subjecting the individual to one or more application specific tests and recording the results in said database;
subjecting the individual to one or more situational action response tests and recording the results in said database;
scoring the results of said tests and classifying the test results based upon a predetermined set of rules and storing the classified results in said database; and
comparing said classified results to a predetermined set of references to develop a set of data representing preferences and other characteristics of the individual.

2. A method for determining certain personal characteristics and preferences of an individual as recited in claim 1, and further comprising the step of:
using said set of data to provide compatible content, advice or personal introductions to said individual.

3. A method for determining certain personal characteristics and preferences of an individual as recited in claim 1 wherein said personality tests include the Keirsey Temperament Sorter.

4. A method for determining certain personal characteristics and preferences of an individual as recited in claim 1 wherein said application specific tests are selected from the group consisting of personality tests, demographics tests, on-line and off-line behavioral response tests, psychographic tests, and life style and quality of life tests.

5. A method for determining certain personal characteristics and preferences of an individual as recited in claim 1 wherein said predetermined set of references include characteristics selected from the group consisting of personality traits, skills, competencies, attitudes, beliefs, behaviors, psychographic, demographic and resume items.

6. A method for determining certain personal characteristics and preferences of an individual as recited in claim 1 wherein the format of each said test is selected from the group consisting of text presentation, video presentation, audio presentation, photographic/image presentation, and combinations thereof.

7. A system for enabling the online determination of certain personal characteristics and preferences of an individual, comprising:
means for subjecting the individual to one or more personality tests and recording the results in a database;
means for subjecting the individual to one or more application specific tests and recording the results in said database;
means for subjecting the individual to one or more situational action response tests and recording the results in said database;
means for scoring the results of said tests and classifying the test results based upon a predetermined set of rules and storing the classified results in said database; and
means for comparing said classified results to a predetermined set of references to develop a set of data representing preferences and other characteristics of the individual.

8. A system for enabling the online determination of certain personal characteristics and preferences of an individual as recited in claim 7, and further comprising:
means for using said set of data to provide compatible content, advice or personal introductions to said individual.

9. A system for enabling the online determination of certain personal characteristics and preferences of an individual as recited in claim 7 wherein said personality tests include the Keirsey Temperament Sorter.

10. A system for enabling the online determination of certain personal characteristics and preferences of an individual, as recited in claim 7 wherein said application specific tests are selected from the group consisting of personality tests, demographics tests, on-line and off-line behavioral response tests, psychographic tests, and life style and quality of life tests.

11. A method for determining certain personal characteristics and preferences of an individual as recited in claim 7 wherein said predetermined set of references include characteristics selected from the group consisting of personality traits, skills, competencies, attitudes, beliefs, behaviors, psychographic, demographic and resume items.

12. A method for determining certain personal characteristics and preferences of an individual as recited in claim 7 wherein the format of each said test is selected from the group consisting of text presentation, video presentation, audio presentation, photographic/image presentation, and combinations thereof.
